(19) United States
(12) Patent Application Publication
(10) Pub. No.: US 2017/0229146 A1
(43) Pub. Date: Aug. 10, 2017

(54) REAL-TIME CONTENT EDITING WITH LIMITED INTERACTIVITY

(71) Applicant: Justin Garak, Toronto (CA)

(72) Inventor: Justin Garak, Toronto (CA)

(21) Appl. No.: 15/040,945

(22) Filed: Feb. 10, 2016

(51) Int. Cl. G11B 27/00; G06K 9/00; G06F 3/16; G06F 3/0484; G06F 3/0481

(52) U.S. Cl. CPC G11B 27/00; G06F 3/04842; G06F 3/04817; G06F 3/04845; G06F 3/165; G06F 3/04847; G06K 9/00758

(57) ABSTRACT

A first real-time content filter and a second real-time content filter are stored, the first real-time content filter being associated with a first predetermined limited input, and the second real-time content filter being associated with a second predetermined limited input, the first predetermined limited input being different from the second predetermined limited input. Content is captured of a subject, the content comprising video content. A first limited input is received. It is determined whether the first limited input matches any of the first predetermined limited input or the second predetermined limited input. The first real-time content filter is selected responsive to a determination the first limited input matches the first predetermined limited input. The content is edited using the first real-time content filter while the content is being captured.

### BRIEF DESCRIPTION OF THE DRAWINGS

FIG. 1 shows a block diagram of an example of an environment capable of providing real-time content editing with limited interactivity.

FIG. 2 shows a flowchart of an example method of operation of an environment capable of providing real-time content editing with limited interactivity.

FIG. 3 depicts a block diagram of an example of a limited interactivity content editing system.

FIG. 4 shows a flowchart of an example method of operation of a limited interactivity content editing system.

FIG. 5 shows a flowchart of an example method of operation of a limited interactivity content editing system.

FIG. 6 shows a flowchart of an example method of operation of a limited interactivity content editing system performing a silence limited editing action.

FIG. 7 shows a flowchart of an example method of operation of a limited interactivity content editing system performing an un-silence limited editing action.

FIG. 8 shows a flowchart of an example method of operation of a limited interactivity content editing system performing a delete limited editing action.

FIG. 9 shows a flowchart of an example method of operation of a limited interactivity content editing system performing an audio image limited editing action.

FIG. 10 shows a block diagram of an example of a content storage and streaming system.

FIG. 11 shows a flowchart of an example method of operation of a content storage and streaming system.

FIG. 12 shows a block diagram of an example of a filter creation and storage system.

FIG. 13 shows a flowchart of an example method of operation of a filter creation and storage system.

FIG. 14 shows a block diagram of an example of a filter recommendation system 1402.

FIG. 15 shows a flowchart of an example method of operation of a filter recommendation system.

FIG. 16 shows a block diagram of an example of a playback device.

FIG. 17 shows a flowchart of an example method of operation of a playback device.

FIG. 18 shows an example of a limited editing interface.

FIG. 19 shows an example of a limited editing interface.

FIG. 20 shows a block diagram of an example of a computer system.

### DETAILED DESCRIPTION

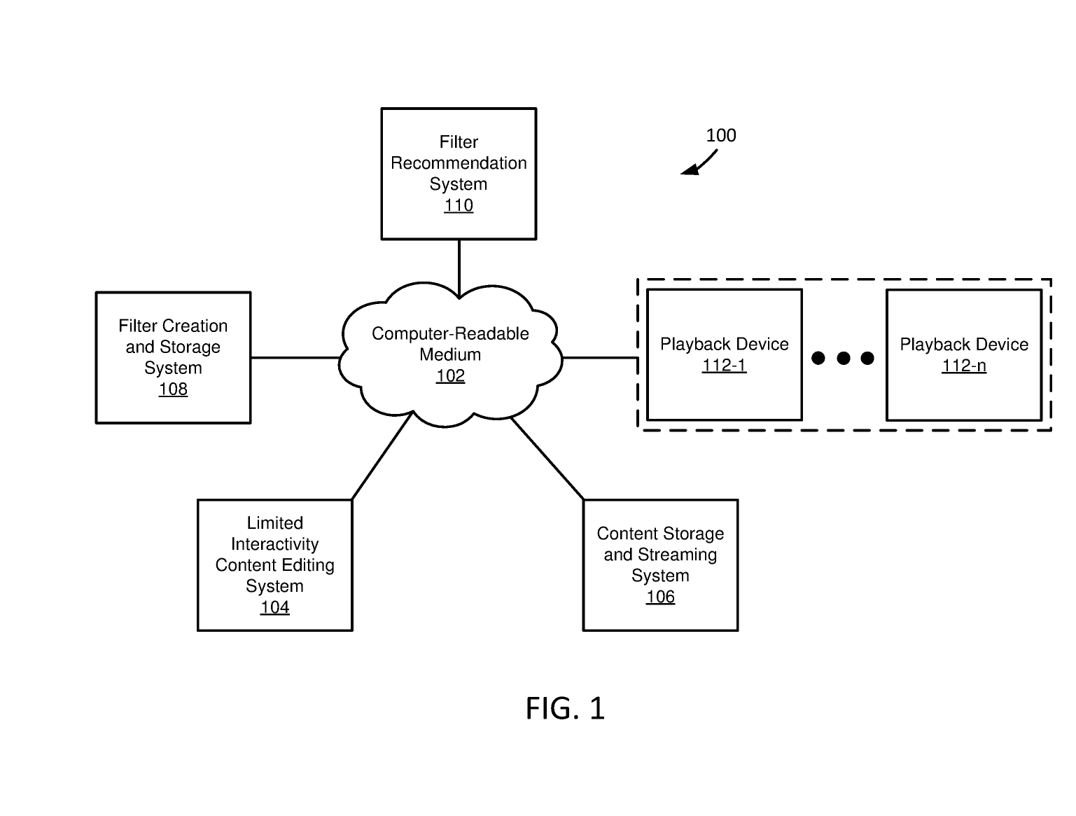

FIG. 1 shows a block diagram of an example of an environment 100 capable of providing real-time content editing with limited interactivity. The environment 100 includes a computer-readable medium 102, a limited interactivity content editing system 104, a content storage and streaming system 106, a filter creation and storage system 108, a filter recommendation system 110, and playback devices 112-1 to 112-n (individually, the playback device 112, collectively, the playback devices 112).

In the example of FIG. 1, the limited interactivity content editing system 104, the content storage and streaming system 106, the filter creation and storage system 108, the filter recommendation system 110, and the playback devices 112, are coupled to the computer-readable medium 102. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware. The computer-readable medium 102 is intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

In the example of FIG. 1, the computer-readable medium 102 can include a networked system including several computer systems coupled together, such as the Internet, or a device for coupling components of a single computer, such as a bus. The term “Internet” as used in this paper refers to a network of networks using certain protocols, such as the TCP/IP protocol, and possibly other protocols such as the hypertext transfer protocol (HTTP) for hypertext markup language (HTML) documents making up the World Wide Web (the web). Content is often provided by content servers, which are referred to as being “on” the Internet. A web server, which is one type of content server, is typically at least one computer system, which operates as a server computer system and is configured to operate with the protocols of the web and is coupled to the Internet. The physical connections of the Internet and the protocols and communication procedures of the Internet and the web are well known to those of skill in the relevant art. For illustrative purposes, it is assumed the computer-readable medium 102 broadly includes, as understood from relevant context, anything from a minimalist coupling of the components illustrated in the example of FIG. 1, to every component of the Internet and networks coupled to the Internet. In some implementations, the computer-readable medium 102 is administered by a service provider, such as an Internet Service Provider (ISP).

In various implementations, the computer-readable medium 102 can include technologies such as Ethernet, 802.11, worldwide interoperability for microwave access (WiMAX), 3G, 4G, CDMA, GSM, LTE, digital subscriber line (DSL), etc. The computer-readable medium 102 can further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over computer-readable medium 102 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In a specific implementation, the computer-readable medium 102 can include a wired network using wires for at least some communications. In some implementations the computer-readable medium 102 comprises a wireless network. A “wireless network,” as used in this paper can include any computer network communicating at least in part without the use of electrical wires. In various implementations, the computer-readable medium 102 includes technologies such as Ethernet, 802.11, worldwide interoperability for microwave access (WiMAX), 3G, 4G, CDMA, GSM, LTE, digital subscriber line (DSL), etc. The computer-readable medium 102 can further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the computer-readable medium 102 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In a specific implementation, the wireless network of the computer-readable medium 102 is compatible with the 802.11 protocols specified by the Institute of Electrical and Electronics Engineers (IEEE). In a specific implementation, the wireless network of the network 130 is compatible with the 802.3 protocols specified by the IEEE. In some implementations, IEEE 802.3 compatible protocols of the computer-readable medium 102 can include local area network technology with some wide area network applications. Physical connections are typically made between nodes and/or infrastructure devices (hubs, switches, routers) by various types of copper or fiber cable. The IEEE 802.3 compatible technology can support the IEEE 802.1 network architecture of the computer-readable medium 102.

The computer-readable medium 102, the limited interactivity content editing system 104, the content storage and streaming system 106, the filter creation and storage system 108, the filter recommendation system 110, and the playback devices 112, and other applicable systems, or devices described in this paper can be implemented as a computer system, a plurality of computer systems, or parts of a computer system or a plurality of computer systems. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, ISDN modem, cable modem, token ring interface, Ethernet interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to end user devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their end user device.

A computer system can be implemented as an engine, as part of an engine, or through multiple engines. As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud based datastore is a datastore that is compatible with cloud-based computing systems and engines.

In the example of FIG. 1, the limited interactivity content editing system 104 functions to edit, or otherwise adjust, content (e.g., video, audio, images, pictures, etc.) in real-time. For example, the functionality of the limited interactivity content editing system 104 can be performed by one or more mobile devices (e.g., smartphone, cell phone, smartwatch, smartglasses, tablet computer, etc.). In a specific implementation, the limited interactivity content editing system 104 simultaneously, or at substantially the same time, captures and edits content based on, or in response to, limited interactivity. Although typical implementations of the limited interactivity content editing system 104 also include functionality of a playback device, such functionality is not required. For example, it can be desirable to provide limited interactivity content editing systems with reduced functionality in certain circumstances, such as low-cost or small-form factor mobile devices provided to guests of an event (e.g., concert, sporting event, party, etc.).

As used in this paper, limited interactivity includes limited input and/or limited output. In a specific implementation, a limited input includes a limited sequence of inputs, such as button presses, button holds, GUI selections, gestures (e.g., taps, holds, swipes, pinches, etc.), and the like. It will be appreciated that a limited sequence includes a sequence of one (e.g., a single gesture). A limited output, for example, includes an output (e.g., edited content) restricted based on one or more playback device characteristics, such as display characteristics (e.g., screen dimensions, resolution, brightness, contrast, etc.), audio characteristics (fidelity, volume, frequency, etc.), and the like.

In a specific implementation, the limited interactivity content editing system 104 functions to request, receive, and apply (collectively, “apply”) one or more real-time content filters based on limited interactivity. For example, the limited interactivity content editing system 104 can apply, in response to receiving a limited input, a particular real-time content filter associated with that limited input. Generally, real-time content filters facilitate editing, or otherwise adjusting, content while the content is being captured. For example, real-time content filters can cause the limited interactivity content editing system 104 to overlay secondary content (e.g., graphics, text, audio, video, images, etc.) on top of content being captured, adjust characteristics (e.g., visual characteristics, audio characteristics, etc.) of one or more subjects (e.g., persons, structures, geographic features, audio tracks, video tracks, events, etc.) within content being captured, adjust content characteristics (e.g., display characteristics, audio characteristics, etc.) of content being captured, and the like.

In a specific implementation, the limited interactivity content editing system 104 adjusts, in real-time, one or more portions of content without necessarily adjusting other portions of that content. For example, audio characteristics associated with a particular subject can be adjusted without adjusting audio characteristics associated with other subjects. This can provide, for example, a higher level of editing granularity than conventional systems.

In the example of FIG. 1, the filtered content storage and streaming system 106 functions to maintain a repository of content and to provide content for playback (e.g., video playback and/or audio playback). For example, the system 106 can be implemented using a cloud-based storage platform (e.g., AWS), on one or more mobile devices (e.g., the one or more mobile devices performing the functionality of the limited interactivity content editing system 104), or otherwise. It will be appreciated that content includes previously captured edited and unedited content (or, “recorded content”), as well as real-time edited and unedited content (or, “real-time content”). More specifically, real-time content includes content that is received by the content storage and streaming system 106 while the content is being captured.

In a specific implementation, the filtered content storage and steaming system 106 provides content for playback via one or more content streams. The content streams include real-time content streams that provide content for playback while the content is being edited and/or captured, and recorded content streams that provide recorded content for playback.

In the example of FIG. 1, the filter creation and storage system 108 provides create, read, update, and delete (or, “CRUD”) functionality for real-time content filters, as well as maintaining a repository of real-time content filters. For example, the filter creation and storage system 108 can be implemented using a cloud-based storage platform (e.g., AWS), on one or more mobile devices (e.g., the one or more mobile devices performing the functionality of the limited interactivity content editing system 104), or otherwise. In a specific implementation, real-time content filters include some or all of the following filter attributes:
Filter Identifier: an identifier that uniquely identifies the real-time content filter.
Filter Action(s): one or more editing actions triggered by application of the real-time content filter to content being captured. For example, editing actions can include overlaying secondary content on top of content being captured, adjusting characteristics of one or more subjects within content being captured, adjusting content characteristics of content being captured, and/or the like.
Limited Input: a limited input associated with the real-time content filter, such as a limited sequence of button presses, button holds, gestures, and the like.
Limited Output: a limited output associated with the real-time content filter, such as playback device characteristics.
Content Type: one or more types of content suitable for editing with the real-time content filter. For example, content types can include audio, video, images, pictures, and/or the like.
Category: one or more categories associated with the real-time content filter. For example, categories can include music, novelists, critiques, bloggers, short commentators, and/or the like.

In the example of FIG. 1, the filter recommendation system 110 functions to identify one or more contextually relevant real-time content filters. For example, the system 110 can be implemented using a cloud-based storage platform (e.g., AWS), on one or more mobile devices (e.g., the one or more mobile devices performing the functionality of the limited interactivity content editing system 104), or otherwise. In a specific implementation, context is based on images and/or audio recognized within content, playback device characteristics of associated playback devices, content characteristics, content attributes, and the like. For example, and as discussed further below, content attributes can include a content category (e.g., music). Identification of contextually relevant real-time content filters can, for example, increase ease of operation by providing a limited set of real-time content filters to select from, e.g., as opposed to selecting from among all stored real-time content filters.

In the example of FIG. 1, the playback devices 112 function to present real-time and recorded content (collectively, “content”). For example, the playback devices 112 can include one or more mobile devices (e.g., the one or more mobile devices performing the functionality of the limited interactivity content editing system 104), desktop computers, or otherwise. In a specific implementation, the playback devices 112 are configured to stream real-time content via one or more real-time content streams, and stream recorded content via one or more recorded content streams.

In a specific implementation, when a playback device 112 presents content, there are multiple (e.g., two) areas of playback focus and playback control. For example, a first area (or, image area) can be an image that represents the content. A second area (or, audio area) can be a unique designed graphical rectangular bar that represents audio portion of the content. For every ten seconds, or other predetermined amount of time, of audio, there can be a predetermined number of associated images (e.g., one image). The playback device 112 can scroll, or otherwise navigate, through the image throughout entire audio playback; however, in some implementations, the playback device 112 does not control a destination of audio playback. The playback device 112 can control audio playback by scrolling, or otherwise navigating, through a designated audio portion (e.g., the audio area), such as a rectangular audio box below the image area. The audio box, for example, can include only one level of representation for speech bubbles.

In a specific implementation, playback of particular content by the playback devices 112 is access controlled. For example, particular content can be associated with one or more accessibility characteristics. In order for a playback device 112 to playback controlled content, appropriate credentials (e.g., age, login credentials, etc.) satisfying the associated one or more accessibility characteristics must be provided.

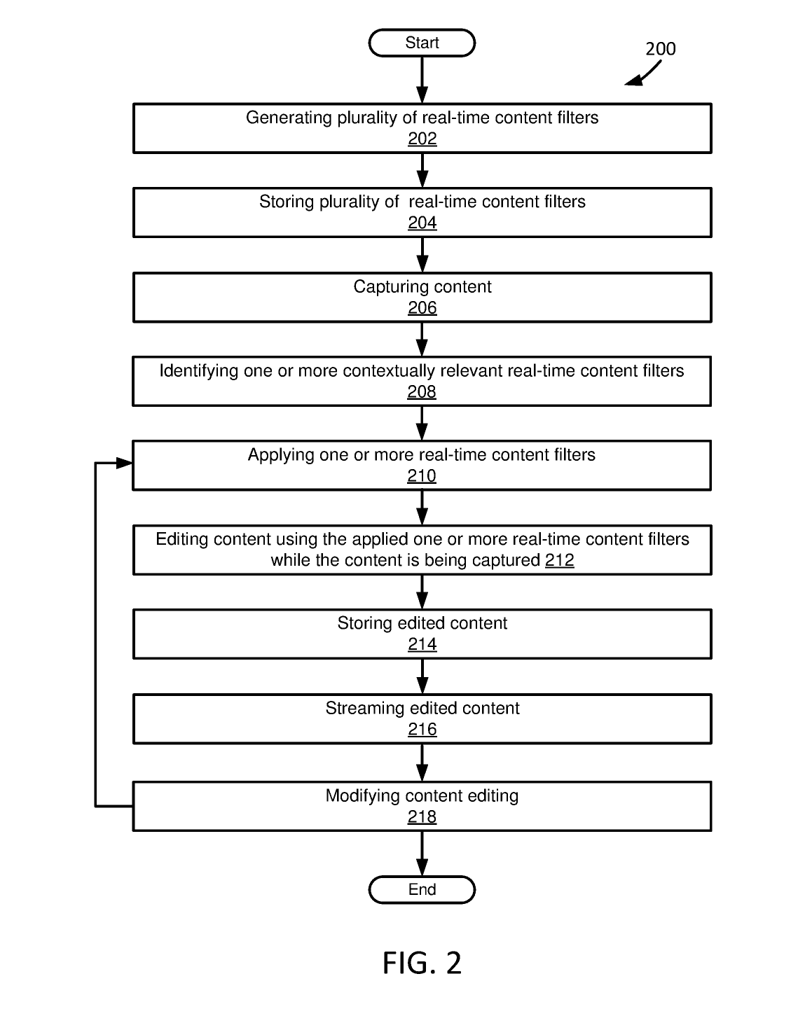

FIG. 2 shows a flowchart 200 of an example method of operation of an environment capable of providing real-time content editing with limited interactivity. In this and other flowcharts described in this paper, the flowchart illustrates by way of example a sequence of modules. It should be understood the modules can be reorganized for parallel execution, or reordered, as applicable. Moreover, some modules that could have been included may have been removed to avoid providing too much information for the sake of clarity and some modules that were included could be removed, but may have been included for the sake of illustrative clarity.

In the example of FIG. 2, the flowchart 200 starts at module 202 where a filter creation and storage system generates a plurality of real-time content filters. In a specific implementation, real-time content filters are generated based on one or more filter attributes. For example, the one or more filter attributes can be received via a user or administrator interfacing with a GUI.

In the example of FIG. 2, the flowchart 200 continues to module 204 where the filter creation and storage system stores the plurality of real-time content filters. In a specific implementation, the filter creation and storage system stores the real-time content filters in a filter creation and storage system datastore based on one or more of the filter attributes. For example, real-time content filters can be organized into various filter libraries based on the filter category attribute.

In the example of FIG. 2, the flowchart 200 continues to module 206 where a limited interactivity content editing system captures content. For example, the limited interactivity content editing system can capture audio and/or video of one or more subjects performing one or more actions (e.g., speaking, singing, moving, etc.), and the like. In a specific implementation, content capture is initiated in response to limited input received by the limited interactivity content editing system. For example, a camera, microphone, or other content capture device associated with the limited interactivity content editing system, can be triggered to capture the content based on the limited input. In a specific implementation, one or more playback devices present the content while it is being captured.

In a specific implementation, the limited interactivity content editing system transmits the content to a content storage and streaming system. For example, it can transmit the content in real-time (e.g., while the content is being captured), at various intervals (e.g., e.g., every 10 seconds, etc.), and the like.

In the example of FIG. 2, the flowchart 200 continues to module 208 where a filter recommendation system identifies one or more contextually relevant real-time content filters from the plurality of real-time content filters stored by the filter creation and storage system. In a specific implementation, the one or more identifications are based on one or more filter attributes, images and/or audio recognized within the content being captured, and characteristics of associated playback devices. For example, if the content comprises a subject singing, or otherwise performing music, the filter recommendation system can recommend real-time content filters associated a music category. In a specific implementation, the one or more real-time content filter identifications are transmitted to the limited interactivity content editing system.

In the example of FIG. 2, the flowchart 200 continues to module 210 where the limited interactivity content editing system selects, receives, and applies (collectively, “applies”) one or more real-time content filters based on a limited input. In a specific implementation, receipt of the limited input triggers the limited interactivity content editing system to apply one or more real-time content filters (e.g., a recommended real-time content filter or other stored real-time content filter) to the content being captured.

In the example of FIG. 2, the flowchart 200 continues to module 212 where the limited interactivity content editing system uses the one or more selected real-time content filters to edit, or otherwise adjust, at least a portion of the content while the content is being captured. For example, a first real-time content filter can adjust audio characteristics of one or more audio tracks (e.g., a subject singing a song), a second real-time content filter can overlay graphics on a portion of a video track (e.g., video of the subject singing), a third real-time content filter can adjust a resolution of the video track, and so forth.

In the example of FIG. 2, the flowchart 200 continues to module 214 where a content storage and streaming system receives content from the limited interactivity content editing system. In a specific implementation, the received content is stored based on the one or more filters used to edit the content. For example, content edited with a filter associated with a particular category (e.g., music) can be stored with other content edited with a real-time content filter associated with the same particular category.

In the example of FIG. 2, the flowchart 200 continues to module 216 where the content storage and streaming system provides content for presentation by one or more playback devices. In a specific implementation, the content storage and streaming system provides the content via one or more content streams (e.g., real-time content stream or recorded content stream) to the playback devices.

In the example of FIG. 2, the flowchart 200 continues to module 218 where the limited interactivity content editing system modifies editing of content. For example, one or more real-time content filters can be removed, and/or one or more different real-time content filters can be applied. See steps 208-218.

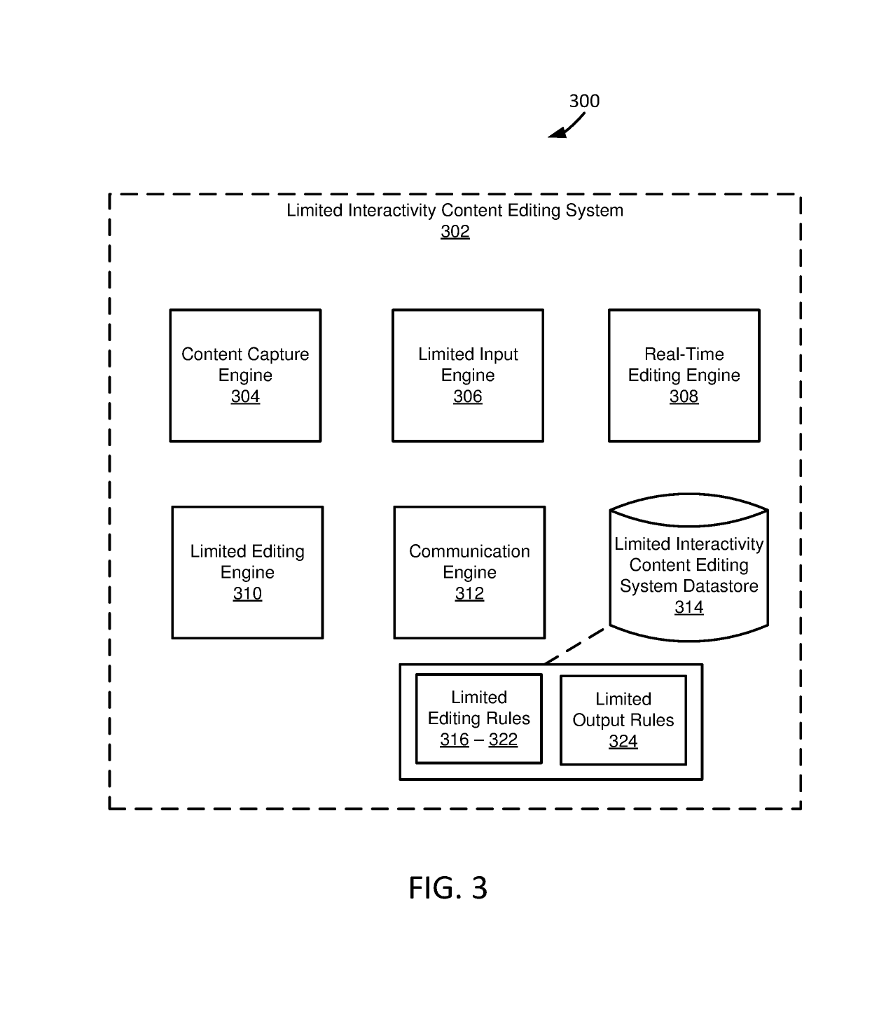

FIG. 3 depicts a block diagram 300 of an example of a limited interactivity content editing system 302. In the example of FIG. 3, the example limited interactivity content editing system 302 includes a content capture engine 304, a limited input engine 306, a real-time editing engine 308, a limited editing engine 310, a communication engine 312, and a limited interactivity content editing system datastore 314.

In the example of FIG. 3, the content capture engine 304 functions to record content of one or more subjects. For example, the content capture engine 304 can utilize one or more sensors (e.g., cameras, microphones, etc.) associated with the limited interactivity content editing system 302 to record content. In a specific implementation, the one or more sensors are included in the one or more devices performing the functionality of the limited interactivity content editing system 302, although in other implementations, it can be otherwise. For example, the one or more sensors can be remote from the limited interactivity content editing system 302 and communicate sensor data (e.g., video, audio, images, pictures, etc.) to the system 302 via a network. In a specific implementation, recorded content is stored, at least temporarily (e.g., for transmission to one or more other systems), in the limited interactivity content editing system datastore 314.

In the example of FIG. 3, the limited input engine 306 functions to receive and process limited input. In a specific implementation, the limited input engine 306 is configured to generate a real-time edit request based on a received limited sequence of inputs. For example, the real-time edit request can include some or all of the following attributes:
Request Identifier: an identifier that uniquely identifies the real-time edit request.
Limited Input: a limited input associated with the request, such as a limited sequence of button presses, button holds, gestures, and the like.
Limited Output: a limited output associated with the request, such as playback device characteristics.
Filter Identifier: an identifier uniquely identifying a particular real-time content filter.
Filter History: a history of previously applied real-time content filters associated with the limited interactivity content editing system 302. In a specific implementation, the filter history can be stored in the datastore 314.
Filter Preferences: one or filter preferences associated with the limited interactivity content editing system 302. For example, filter preferences can indicate a level of interest (e.g., high, low, never apply, always apply, etc.) in one or more filter categories (e.g., music) or other filter attributes. In a specific implementation, filter preferences are stored in the datastore 314.
Default Filters: one or more default filters associated with the limited interactivity content editing system 302. In a specific implementation, default filters can be automatically applied by including associated filter identifiers in the filter identifier attribute of the real-time edit request.

In a specific implementation, the limited input engine 306 is capable of formatting the real-time edit request for receipt and processing by a variety of different systems, including a filter creation and storage system, a filter recommendation system, and the like.

In the example of FIG. 3, the real-time editing engine 308 functions to apply real-time content filters to content while the content is being captured. More specifically, the engine 308 edits content, or portions of content, in real-time based on the filter attributes of the applied real-time content filters.

In a specific implementation, the real-time editing engine 308 is configured to identify playback device characteristics based upon one or more limited output rules 324 stored in the limited interactivity content editing system datastore 314. For example, the limited output rules 324 can define playback device characteristic values, such as values for display characteristics, audio characteristics, and the like. Each of the limited output rule 324 values can be based on default values (e.g., assigned based on expected playback device characteristics), actual values (e.g., characteristics of associated playback devices), and/or customized values. In a specific implementation, values can be customized (e.g., from a default value or NULL value) to reduce storage capacity for storing content, reduce bandwidth usage for transmitting (e.g., streaming) content, and the like.

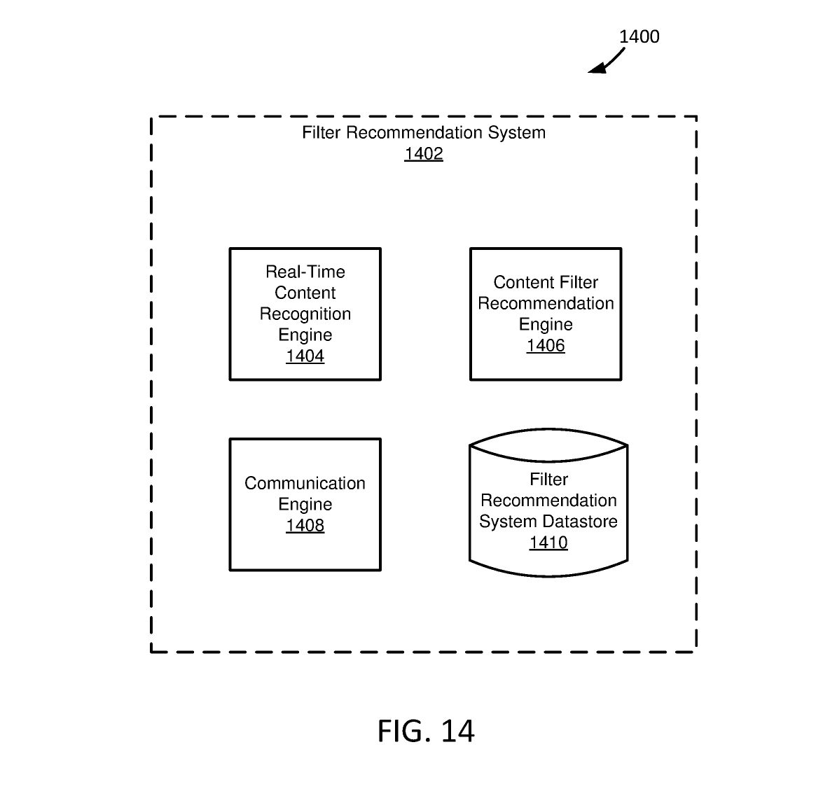

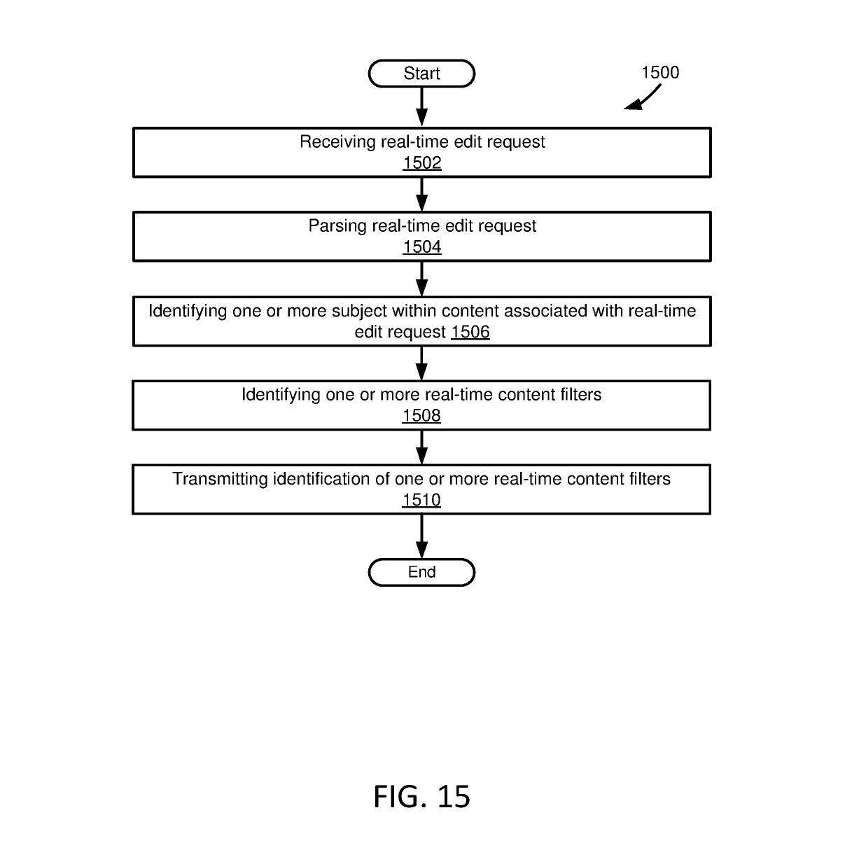

In the example of FIG. 3, the limited editing engine 310 functions to edit content, or portions of content, based on limited input. For example, the limited editing engine 310 can silence, un-silence, and/or delete portions of content based on limited input. Examples of interfaces for receiving limited input are shown in FIGS. 14 and 15.

In a specific implementation, the limited editing engine 310 is configured to identify and execute one or more limited editing rules 316-322 based on received limited input. In the example of FIG. 3, the limited editing rules 316-322 are stored in the datastore 314, although in other implementations, the limited editing rules 316-322 can be stored otherwise, e.g., in one or more associated systems or datastores.

In a specific implementation, the limited editing rules 316-322 define one or more limited editing actions that are triggered in response to limited input. For example, the limited editing rules 316-322 can be defined as follows:

Silence Limited Editing Rules 316

In a specific implementation, the silence limited editing rules 316, when executed, trigger the limited editing engine 310 to insert an empty (or, blank) portion of content into recorded content. An insert start point (e.g., time 1 m:30 s of a 3 m:00 s audio recording) is set (or, triggered) in response to a first limited input. For example, the first limited input can be holding a button or icon on an interface configured to receive limited input, such as interface 1802 shown in FIG. 14. An insert end point (e.g., 2 m:10 s of the 3 m:00 audio recording) is set in response to a second limited input. For example, the second limited input can be releasing the button or icon held in the first limited input. The empty portion of content is inserted into the recorded content at the insert start point and terminates at the insert end point.

In a specific implementation, the insert end point is reached in real-time, e.g., holding a button for 40 seconds inserts a 40 second empty portion of content into the recorded content. Alternatively, or additionally, the insert end point can be reached based on a third limited input. For example, while holding the button, a slider (or other GUI element), can be used to select a time location (e.g., 2 m:10 s) to set the insert end point. Releasing the button at the selected time location sets the insert end point at the selected time location. This can for example, speed up the editing process and provide additional editing granularity. In a specific implementation, additional content can be inserted into some or all of the empty, or silenced, portion of the recorded content.

Un-Silence Limited Editing Rules 318

In a specific implementation, the un-silence limited editing rules 318, when executed, trigger the limited editing engine 310 to un-silence (or, undo) some or all of the actions triggered by execution of the silence limited editing rules 320. For example, some or all of an empty portion of content inserted into recorded content can be removed. Additionally, content previously inserted into an empty portion can similarly be removed. More specifically, an undo start point (e.g., time 1 m:30 s of a 3 m:00 s audio recording) is set (or, triggered) in response to a first limited input. For example, the first limited input can be holding a button or icon on an interface configured to receive limited input, such as interface 1802 shown in FIG. 14. An undo end point (e.g., 2 m:10 s of the 3 m:00 audio recording) is set in response to a second limited input. For example, the second limited input can be releasing the button or icon held in the first limited input. The specified empty portion of content, beginning at the undo start point and terminating the undo end point, is removed from the recorded content is removed in response to the second limited input.

In a specific implementation, the undo end point is reached in real-time, e.g., holding a button for 40 seconds removes a 40 second empty portion of content previously inserted into the recorded content. Alternatively, or additionally, the undo end point can be reached based on a third limited input. For example, while holding the button, a slider (or other GUI element) can be used to select a time location (e.g., 2 m:10 s) to set the undo end point. Releasing the button at the selected time location sets the undo end point at the selected time location. This can for example, speed up the editing process and provide additional editing granularity.

Delete Limited Editing Rules 320

In a specific implementation, the delete limited editing rules 320, when executed, trigger the limited editing engine 310 to remove a portion of content from recorded content based on limited input. A delete start point (e.g., time 1 m:30 s of a 3 m:00 s audio recording) is set (or, triggered) in response to a first limited input. For example, the first limited input can be holding a button or icon on an interface configured to receive limited input, such as interface 1802 shown in FIG. 14. A delete end point (e.g., 2 m:10 s of the 3 m:00 audio recording) is set in response to a second limited input. For example, the second limited input can be releasing the button or icon held in the first limited input. The portion of content beginning at the delete start point and terminating at the delete end point is removed from the recorded content. Unlike a silence, an empty portion of content is not inserted, rather the content is simply removed and the surrounding portions of content (i.e., the content preceding the delete start point and the content following the delete end point) are spliced together.

In a specific implementation, the delete end point is reached in real-time, e.g., holding a button for 40 seconds removes a 40 second portion of content. Alternatively, or additionally, the delete end point can be reached based on a third limited input. For example, while holding the button, a slider (or other GUI element), can be used to select a time location (e.g., 2 m:10 s) to set the delete end point. Releasing the button at the selected time location sets the delete end point at the selected time location. This can for example, speed up the editing process and provide additional editing granularity.

Audio Image Limited Editing Rules 322

In a specific implementation, the audio image limited editing rules 322, when executed, trigger the limited editing engine 310 to associate (or, link) one or more images with a particular portion of content. For example, the one or more images can include a picture or a video of a predetermined length (e.g., 10 seconds). More specifically, an audio image start point (e.g., time 1 m:30 s of a 3 m:00 s audio recording) is set (or, triggered) in response to a first limited input. For example, the first limited input can be holding a button or icon on an interface configured to receive limited input, such as interface 1902 shown in FIG. 15. An audio image end point (e.g., 2 m:10 s of the 3 m:00 audio recording) is set in response to a second limited input. For example, the second limited input can be releasing the button or icon held in the first limited input. The one or more images are associated with the particular portion of content such that the one or more images are presented during playback of the particular portion of content, i.e., beginning at the audio image start point and terminating at the audio image end point.

In a specific implementation, the audio image end point is reached in real-time, e.g., holding a button for 40 seconds links the one or more images to that 40 second portion of content. Alternatively, or additionally, the audio image end point can be reached based on a third limited input. For example, while holding the button, a slider (or other GUI element) can be used to select a time location (e.g., 2 m:10 s) to set the audio image end point. Releasing the button at the selected time location sets the audio image end point at the selected time location. This can for example, speed up the editing process and provide additional editing granularity.

In the example of FIG. 3, the communication engine 312 functions to send requests to and receive data from one or a plurality of systems. The communication engine 312 can send requests to and receive data from a system through a network or a portion of a network. Depending upon implementation-specific or other considerations, the communication engine 312 can send requests and receive data through a connection, all or a portion of which can be a wireless connection. The communication engine 312 can request and receive messages, and/or other communications from associated systems. Received data can be stored in the limited interactivity content datastore 314.

In the example of FIG. 3, the limited interactivity content datastore 314 further functions as a buffer or cache. For example, the datastore 314 can store limited input, content, communications received from other systems, content and other data to be transmitted to other systems, etc., and the like.

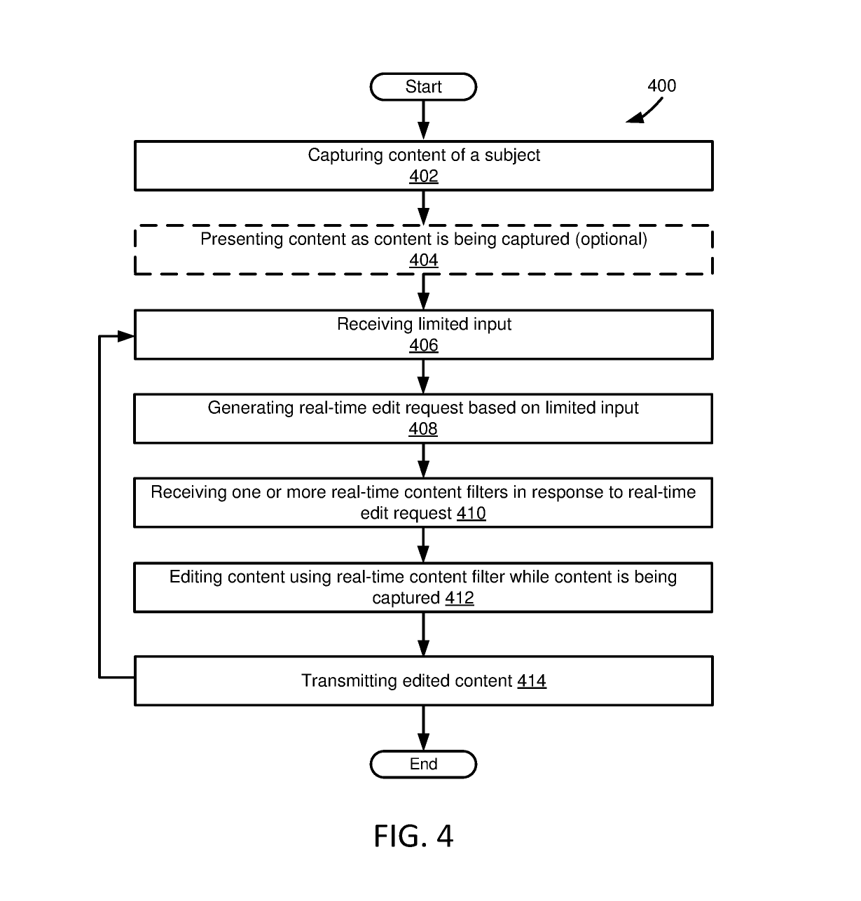

FIG. 4 shows a flowchart 400 of an example method of operation of a limited interactivity content editing system.

In the example of FIG. 4, the flowchart 400 starts at module 402 where a limited interactivity content editing system captures content of a subject. In a specific implementation, a content capture engine captures the content.

In the example of FIG. 4, the flowchart 400 continues to module 404 where the limited interactivity content editing system, assuming it includes functionality of a playback device, optionally presents the content as it is being captured. In a specific implementation, a playback device presents the content.

In the example of FIG. 4, the flowchart 400 continues to module 406 where the limited interactivity content editing system receives a limited input. In a specific implementation, the limited input is received by a limited input engine.

In the example of FIG. 4, the flowchart 400 continues to module 408 where the limited interactivity content editing system generates a real-time edit request based on the limited input. In a specific implementation, the real-time edit request is generated by the limited input engine.

In the example of FIG. 4, the flowchart 400 continues to module 410 where the limited interactivity content editing system receives one or more real-time content filters in response to the real-time edit request. In a specific implementation, a communication engine receives the one or more real-time content filters.

In the example of FIG. 4, the flowchart 400 continues to module 412 where the limited interactivity content editing system edits, or otherwise adjusts, the content in real-time using the received one or more real-time content filters. In a specific implementation, a real-time content editing engine edits the content by applying the received one or more content filters to one or more portion of the content being captured. For example, a first real-time content filter can be applied to an audio track of the content (e.g., a person singing) to perform voice modulation or otherwise adjust vocal characteristics; a second real-time content filter can be applied to add one or more additional audio tracks (e.g., instrumentals and/or additional vocals); a third real-time content filter can be applied to overlay graphics onto to one or more video portions (or, video tracks) of the content; and so forth.

In the example of FIG. 4, the flowchart 400 continues to module 414 where the limited interactivity content editing system transmits the edited content. In a specific implementation, the communication engine transmits the edited content to a content storage and streaming system.

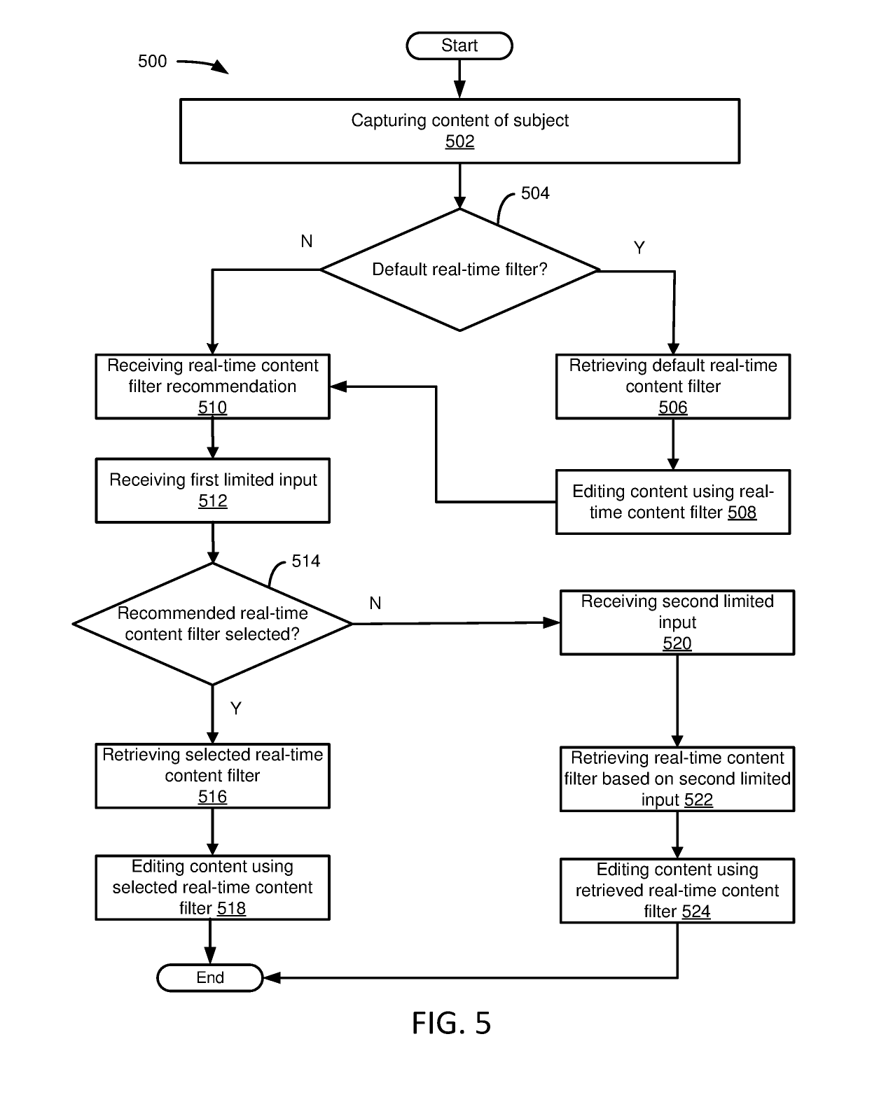

FIG. 5 shows a flowchart 500 of an example method of operation of a limited interactivity content editing system.

In the example of FIG. 5, the flowchart 500 starts at module 502 where a limited interactivity content editing system captures content of a subject. In a specific implementation, a content capture engine captures the content.

In the example of FIG. 5, the flowchart 500 continues to module 504 where the limited interactivity content editing system determines whether one or more default real-time filters should be applied to the content. In a specific implementation, default real-time content filters are applied without receiving any input, limited or otherwise. For example, default filter rules stored in a limited interactivity content editing system datastore can define trigger conditions that, when satisfied, cause the limited interactivity content editing system to apply one or more default real-time content filters. In a specific implementation, a real-time editing engine determines whether one or more default real-time content filters should be applied.

In the example of FIG. 5, the flowchart 500 continues to module 506 where, if it is determined one or more default real-time content filters should be applied, the limited interactivity content editing system retrieves the one or more default real-time content filters. In a specific implementation, a communication engine retrieves the one or more default real-time content filters.

In the example of FIG. 5, the flowchart 500 continues to module 508 where the limited interactivity content editing system adjusts the content by applying the one or more retrieved default real-time content filters to at least a portion of the content while the content is being captured (i.e., in real-time). In a specific implementation, the real-time editing engine applies the one or more retrieved default real-time content filters.

In the example of FIG. 5, the flowchart 500 continues to module 510 where the limited interactivity content editing system receives a real-time content filter recommendation. In a specific implementation, the real-time content filter recommendation can be received in response to a recommendation request generated by the real-time content filter recommendation. For example, the recommendation request can include a request for real-time content filters matching one or more filter attributes, a request for real-time content filter associated with a context of the content being captured, and the like.

In the example of FIG. 5, the flowchart 500 continues to module 512 where the limited interactivity content editing system receives and processes a first limited input to either select none, some or all of the recommended real-time content filters. In a specific implementation, a limited input engine receives and process the first limited input.

In the example of FIG. 5, the flowchart 500 continues to module 514 where the limited interactivity content editing system determines, based on the first limited input, if at least some of the one or more recommended real-time content filters are selected. In a specific implementation, the limited input engine receives and process the first limited input.

In the example of FIG. 5, the flowchart 500 continues to module 516 where, if at least some of the one or more recommended real-time content filters are selected, the limited interactivity content editing system retrieves the selected real-time content filters. In a specific implementation, the communication engine retrieves the selected real-time content filters.

In the example of FIG. 5, the flowchart 500 continues to module 518 where the limited interactivity content editing system adjusts the content by applying the selected real-time content filters to at least a portion of the content while the content is being captured (i.e., in real-time). In a specific implementation, the real-time editing engine applies the one or more selected real-time content filters.

In the example of FIG. 5, the flowchart 500 continues to module 520 where, if none of the recommended real-time content filters are selected, the limited interactivity content editing system receives and processes a second limited input. In a specific implementation, the limited input engine receives the second limited input and generates a real-time edit request based on the second limited input.

In the example of FIG. 5, the flowchart 500 continues to module 522 where the limited interactivity content editing system retrieves one or more real-time content filters based on the second limited input. In a specific implementation, a communication engine transmits the real-time edit request and receives one or more real-time content filters in response to the real-time edit request.

In the example of FIG. 5, the flowchart 500 continues to module 524 where the limited interactivity content editing system adjusts the content by applying the received one or more real-time content filters to at least a portion of the content while the content is being captured (i.e., in real-time). In a specific implementation, the real-time editing engine applies the received one or more real-time content filters.

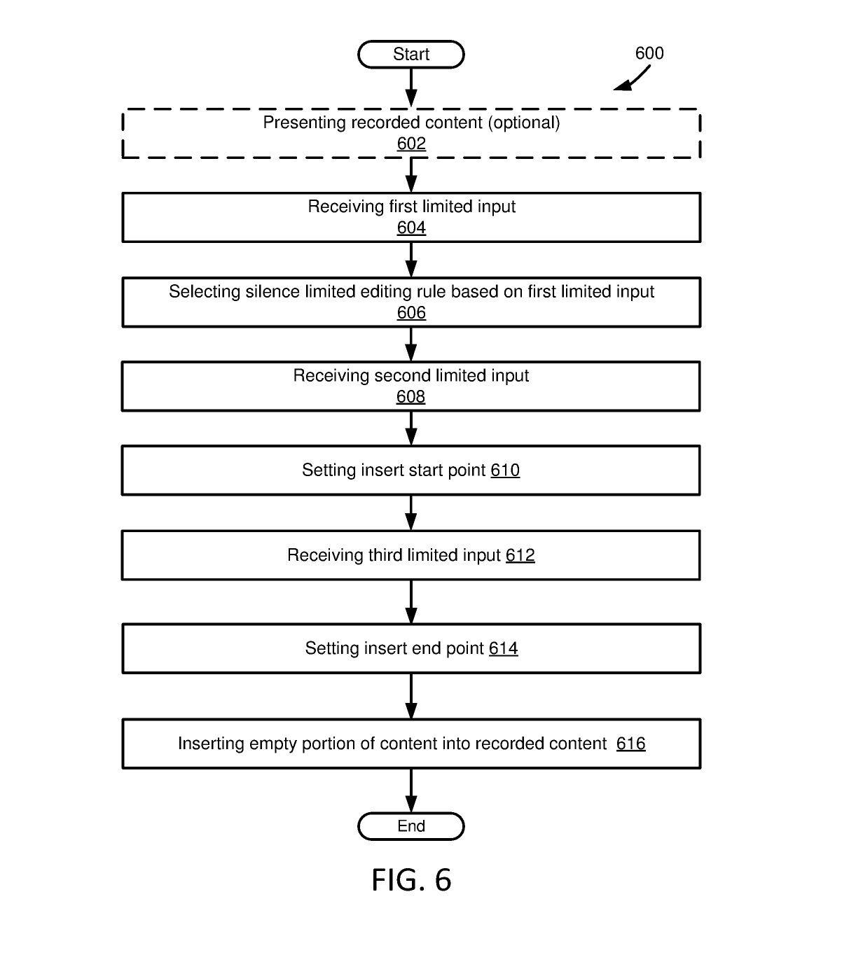

FIG. 6 shows a flowchart 600 of an example method of operation of a limited interactivity content editing system performing a silence limited editing action.

In the example of FIG. 6, the flowchart 600 starts at module 602 where a limited interactivity content editing system, assuming it includes functionality of a playback device, optionally presents recorded content. In a specific implementation, a playback device presents the recorded content.

In the example of FIG. 6, the flowchart 600 continues to module 604 where the limited interactivity content editing system receives a first limited input (e.g., pressing a first button). For example, the button may indicate an associated limited editing action (e.g., “silence”). In a specific implementation, the first limited input is received by a limited input engine.

In the example of FIG. 6, the flowchart 600 continues to module 606 where the limited interactivity content editing system selects a silence limited editing rule based on the first limited input. In a specific implementation, a limited editing engine selects the silence limited editing rule.

In the example of FIG. 6, the flowchart 600 continues to module 608 where the limited interactivity content editing system receives a second limited input (e.g., pressing and holding a second button). In a specific implementation, the limited input engine receives the second limited input. It will be appreciated that in various implementations, the second limited input can include the first limited input (e.g., holding the first button).

In the example of FIG. 6, the flowchart 600 continues to module 610 where the limited interactivity content editing system sets an insert start point based on the second limited input. In a specific implementation, the limited editing engine sets the insert start point.

In the example of FIG. 6, the flowchart 600 continues to module 612 where the limited interactivity content editing system receives a third limited input (e.g., moving a slider to “fast-forward” to, or otherwise select, a different time location of the recorded content). In a specific implementation, the limited input engine receives the third limited input.

In the example of FIG. 6, the flowchart 600 continues to module 614 where the limited interactivity content editing system sets an insert end point based on the third limited input. In a specific implementation, the limited editing engine sets the insert end point.

In the example of FIG. 6, the flowchart 600 continues to module 616 where the limited interactivity content editing system inserts an empty portion of content into the recorded content beginning at the insert start point and ending at the insert end point. In a specific implementation, the limited editing engine inserts the empty portion of content into the recorded content.

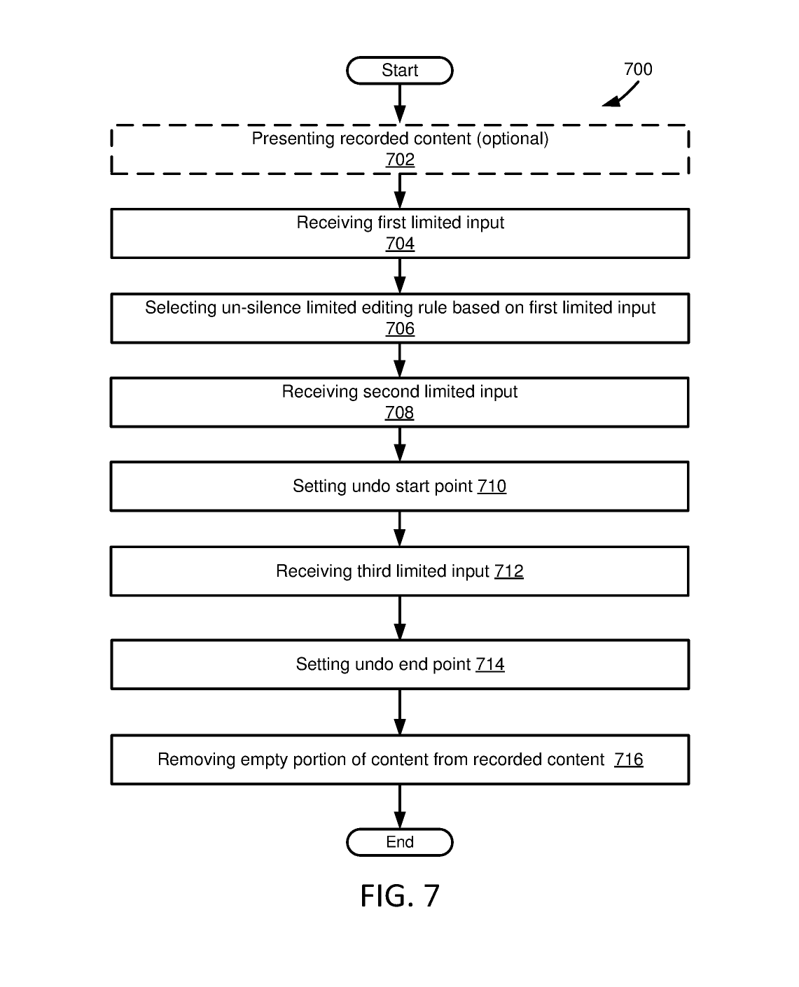

FIG. 7 shows a flowchart 700 of an example method of operation of a limited interactivity content editing system performing an un-silence limited editing action.

In the example of FIG. 7, the flowchart 700 starts at module 702 where a limited interactivity content editing system, assuming it includes functionality of a playback device, optionally presents recorded content. In a specific implementation, a playback device presents the recorded content.

In the example of FIG. 7, the flowchart 700 continues to module 704 where the limited interactivity content editing system receives a first limited input (e.g., pressing a first button). For example, the button may indicate an associated limited editing action (e.g., “un-silence”). In a specific implementation, the first limited input is received by a limited input engine.

In the example of FIG. 7, the flowchart 700 continues to module 706 where the limited interactivity content editing system selects an un-silence limited editing rule based on the first limited input. In a specific implementation, a limited editing engine selects the un-silence limited editing rule.

In the example of FIG. 7, the flowchart 700 continues to module 708 where the limited interactivity content editing system receives a second limited input (e.g., pressing and holding a second button). In a specific implementation, the limited input engine receives the second limited input. It will be appreciated that in various implementations, the second limited input can include the first limited input (e.g., holding the first button).

In the example of FIG. 7, the flowchart 700 continues to module 710 where the limited interactivity content editing system sets an undo start point based on the second limited input. In a specific implementation, the limited editing engine sets the undo start point.

In the example of FIG. 7, the flowchart 700 continues to module 712 where the limited interactivity content editing system receives a third limited input (e.g., moving a slider to “fast-forward” to, or otherwise select, a different time location of the recorded content). In a specific implementation, the limited input engine receives the second limited input.

In the example of FIG. 7, the flowchart 700 continues to module 714 where the limited interactivity content editing system sets an undo end point based on the third limited input. In a specific implementation, the limited editing engine sets the undo end point.

In the example of FIG. 7, the flowchart 700 continues to module 716 where the limited interactivity content editing system removes an empty portion of content from the recorded content beginning at the undo start point and terminating at the undo end point. In a specific implementation, the limited editing engine removes the empty portion of content from the recorded content and splices the surrounding portions of recorded content together (i.e., the recorded content preceding the undo start point and following the undo end point).

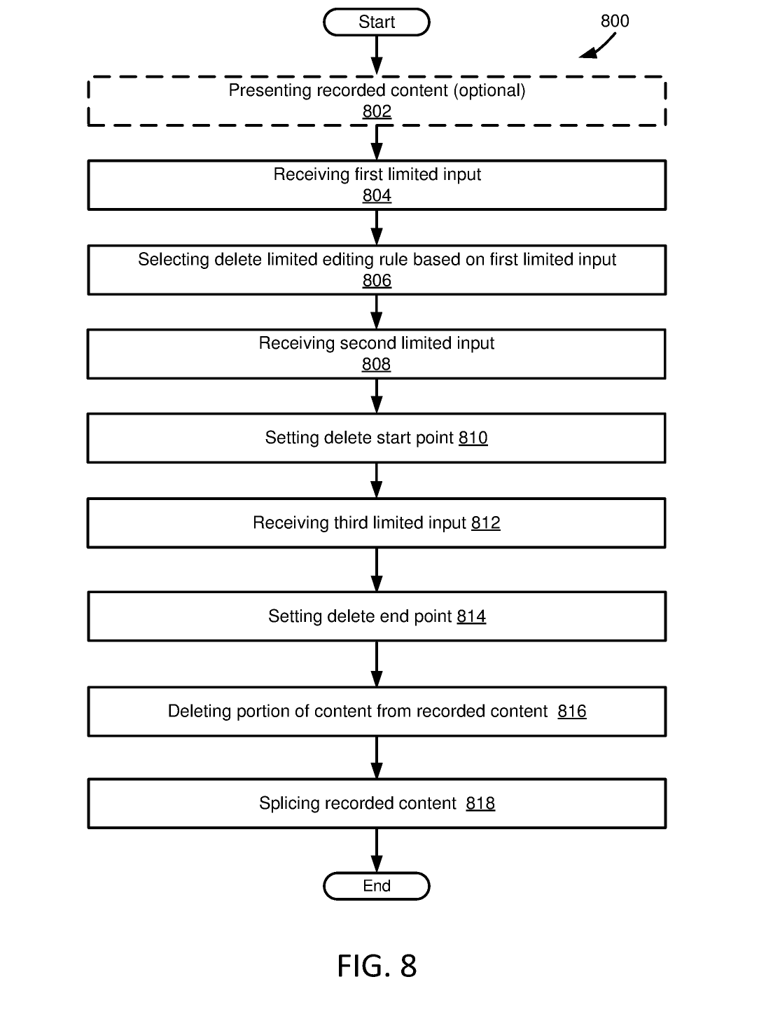

FIG. 8 shows a flowchart 800 of an example method of operation of a limited interactivity content editing system performing a delete limited editing action.

In the example of FIG. 8, the flowchart 800 starts at module 802 where a limited interactivity content editing system, assuming it includes functionality of a playback device, optionally presents recorded content. In a specific implementation, a playback device presents the recorded content.

In the example of FIG. 8, the flowchart 800 continues to module 804 where the limited interactivity content editing system receives a first limited input (e.g., pressing a first button). For example, the button may indicate an associated limited editing action (e.g., “delete”). In a specific implementation, the first limited input is received by a limited input engine.

In the example of FIG. 8, the flowchart 800 continues to module 806 where the limited interactivity content editing system selects a delete limited editing rule based on the first limited input. In a specific implementation, a limited editing engine selects the delete limited editing rule.

In the example of FIG. 8, the flowchart 800 continues to module 808 where the limited interactivity content editing system receives a second limited input (e.g., pressing and holding a second button). In a specific implementation, the limited input engine receives the second limited input. It will be appreciated that in various implementations, the second limited input can include the first limited input (e.g., holding the first button).

In the example of FIG. 8, the flowchart 800 continues to module 810 where the limited interactivity content editing system sets a delete start point based on the second limited input. In a specific implementation, the limited editing engine sets the delete start point.

In the example of FIG. 8, the flowchart 800 continues to module 812 where the limited interactivity content editing system receives a third limited input (e.g., moving a slider to “fast-forward” to, or otherwise select, a different time location of the recorded content). In a specific implementation, the limited input engine receives the second limited input.

In the example of FIG. 8, the flowchart 800 continues to module 814 where the limited interactivity content editing system sets a delete end point based on the third limited input. In a specific implementation, the limited editing engine sets the delete end point.

In the example of FIG. 8, the flowchart 800 continues to module 816 where the limited interactivity content editing system deletes a particular portion of content from the recorded content beginning at the delete start point and terminating at the delete end point. In a specific implementation, the limited editing engine removes the particular portion of content from the recorded content.

In the example of FIG. 8, the flowchart 800 continues to module 818 where the limited interactivity content editing system splices together the portions of recorded content surrounding the deleted particular portion of content (i.e., the recorded content preceding the delete start point and following the delete end point).

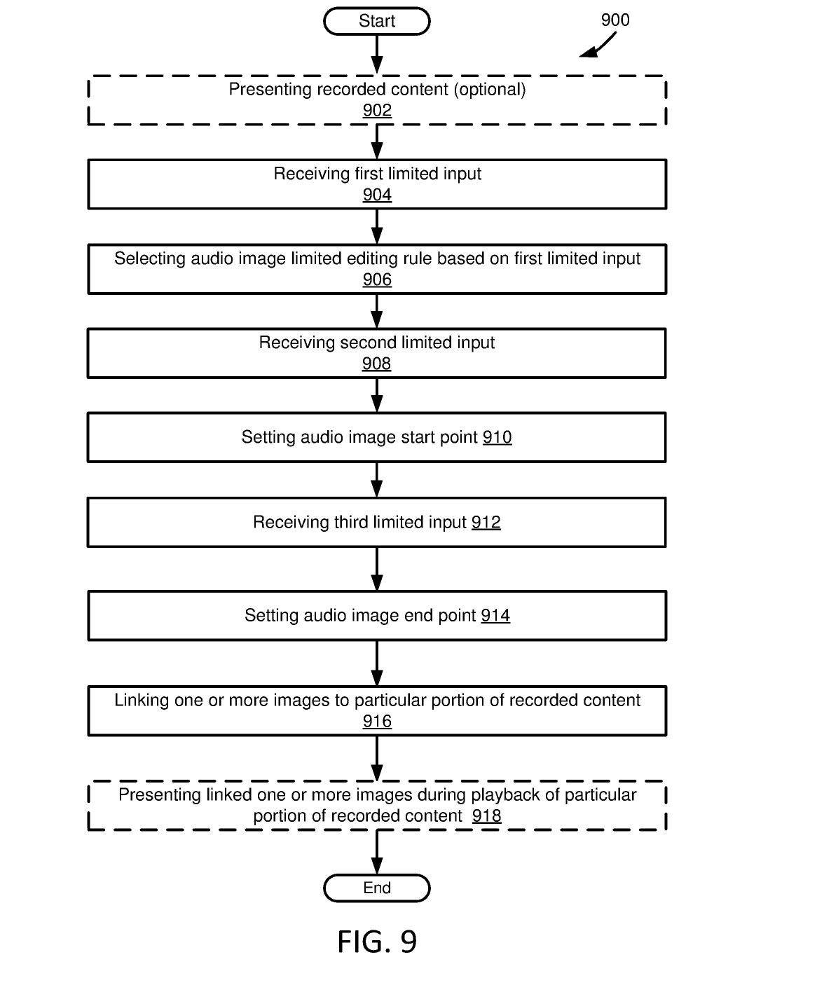

FIG. 9 shows a flowchart 900 of an example method of operation of a limited interactivity content editing system performing an audio image limited editing action.

In the example of FIG. 9, the flowchart 900 starts at module 902 where a limited interactivity content editing system, assuming it includes functionality of a playback device, optionally presents recorded content. In a specific implementation, a playback device presents the recorded content.

In the example of FIG. 9, the flowchart 900 continues to module 904 where the limited interactivity content editing system receives a first limited input (e.g., pressing a first button). For example, the button may indicate an associated limited editing action (e.g., “audio image”). In a specific implementation, the first limited input is received by a limited input engine.

In the example of FIG. 9, the flowchart 900 continues to module 906 where the limited interactivity content editing system selects an audio image limited editing rule based on the first limited input. In a specific implementation, a limited editing engine selects the audio image limited editing rule.

In the example of FIG. 9, the flowchart 900 continues to module 908 where the limited interactivity content editing system receives a second limited input (e.g., pressing and holding a second button). In a specific implementation, the limited input engine receives the second limited input. It will be appreciated that in various implementations, the second limited input can include the first limited input (e.g., holding the first button).

In the example of FIG. 9, the flowchart 900 continues to module 910 where the limited interactivity content editing system sets an audio image start point based on the second limited input. In a specific implementation, the limited editing engine sets the audio image start point.

In the example of FIG. 9, the flowchart 900 continues to module 912 where the limited interactivity content editing system receives a third limited input (e.g., moving a slider to “fast-forward” to, or otherwise select, a different time location of the recorded content). In a specific implementation, the limited input engine receives the second limited input.

In the example of FIG. 9, the flowchart 900 continues to module 914 where the limited interactivity content editing system sets an audio image end point based on the third limited input. In a specific implementation, the limited editing engine sets the audio image end point.

In the example of FIG. 9, the flowchart 900 continues to module 916 where the limited interactivity content editing system links one or more images (e.g., defined by the audio image rule) to a particular portion of the record beginning at the audio image start point and terminating at the audio image end point. In a specific implementation, the limited editing engine performs the linking.

In the example of FIG. 9, the flowchart 900 continues to module 918 where the limited interactivity content editing system optionally presents the linked one or more images during playback of the particular portion of the recorded content, assuming the limited interactivity content editing system includes the functionality of a playback device.

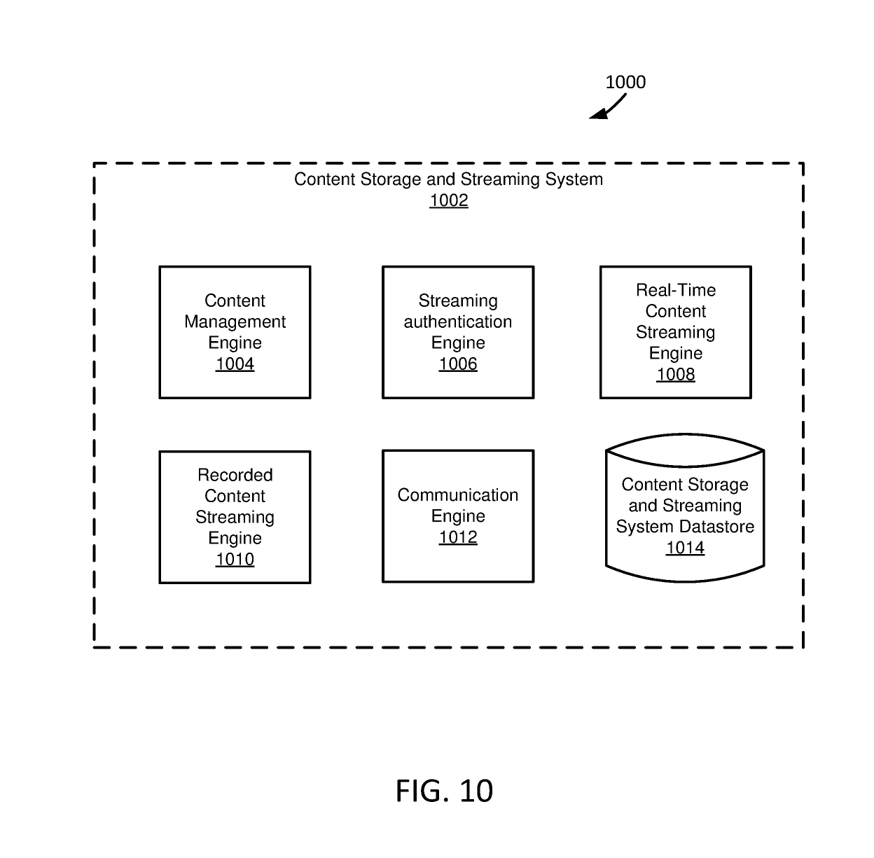

FIG. 10 shows a block diagram 1000 of an example of a content storage and streaming system 1002. In the example of FIG. 10, the content storage and streaming system 1002 includes a content management engine 1004, a streaming authentication engine 1006, a real-time content streaming engine 1008, a recorded content streaming engine 1010, a communication engine 1012, and a content storage and streaming system datastore 1014.

In the example of FIG. 10, the content management engine 1004 functions to create, read, update, delete, or otherwise access real-time content and recorded content (collectively, content) stored in the content storage and streaming system datastore 1012. In a specific implementation, the content management engine 1004 performs any of these operations either manually (e.g., by an administrator interacting with a GUI) or automatically (e.g., in response to content stream requests). In a specific implementation, content is stored in content records associated with content attributes. This can help, for example, locating related content, searching for specific content or type of content, identifying contextually relevant real-time content filters, and so forth. Content attributes can include some or all of the following:
Content Identifier: an identifier that uniquely identifies content.
Content Type: one or more content types associated with the content. Content types can include, for example, video, audio, images, pictures, etc.
Content Category: one or more content categories associated with the content. Content categories can include, for example, music, movie, novelist, critique, blogger, short commentators, and the like.
Content Display Characteristics: one or more display characteristics associated with the content.
Content Audio Characteristics: one or more audio characteristics associated with the content.
Content Accessibility: one or more accessibility attributes associated with the content. For example, playback of the content can be restricted based on age of a viewer, and/or require login credentials to playback associated content.
Content Compression Format: a compression format associated with the content (e.g., MPEG, MP3, JPEG, GIF, etc.).
Content Duration: a playback time duration of the content.
Content Timestamp: one or more timestamps associated with the content, e.g., a capture start timestamp, an edit start timestamp, an edit end timestamp, a capture end timestamp, etc.
Related Content Identifiers: one or more identifiers that uniquely identify related content.
Limited Interactivity Content Editing System Identifier: an identifier that uniquely identifies the limited interactively content edit system that captured and edited the content.

In the example of FIG. 10, the streaming authentication engine 1006 functions to control access to content. In a specific implementation, access is controlled by one or more content attributes. For example, playback of particular content can be restricted based on an associated content accessibility attribute.

In the example of FIG. 10, the real-time content streaming engine 1008 functions to provide real-time content to one or more playback devices. In a specific implementation, the real-time content streaming engine 1008 generates one or more real-time content streams. The real-time content streaming 1008 engine is capable of formatting the real-time content streams based on one or more content attributes of the real-time content (e.g., content compression format attribute, content display characteristics attribute, content audio characteristics attribute, etc.) and streaming target characteristics (e.g., playback device characteristics).

In the example of FIG. 10, the recorded content streaming engine 1010 functions to provide recorded content to one or more playback devices. In a specific implementation, the recorded content streaming engine 1008 generates one or more recorded content streams. The recorded content streaming 1008 engine is capable of formatting the recorded content streams based on one or more content attributes of the real-time content (e.g., content compression format attribute, content display characteristics attribute, content audio characteristics attribute, etc.) and streaming target characteristics (e.g., playback device characteristics).

In the example of FIG. 10, the communication engine 1012 functions to send requests to and receive data from one or a plurality of systems. The communication engine 1012 can send requests to and receive data from a system through a network or a portion of a network. Depending upon implementation-specific or other considerations, the communication engine 1012 can send requests and receive data through a connection, all or a portion of which can be a wireless connection. The communication engine 1012 can request and receive messages, and/or other communications from associated systems. Received data can be stored in the datastore 1014.

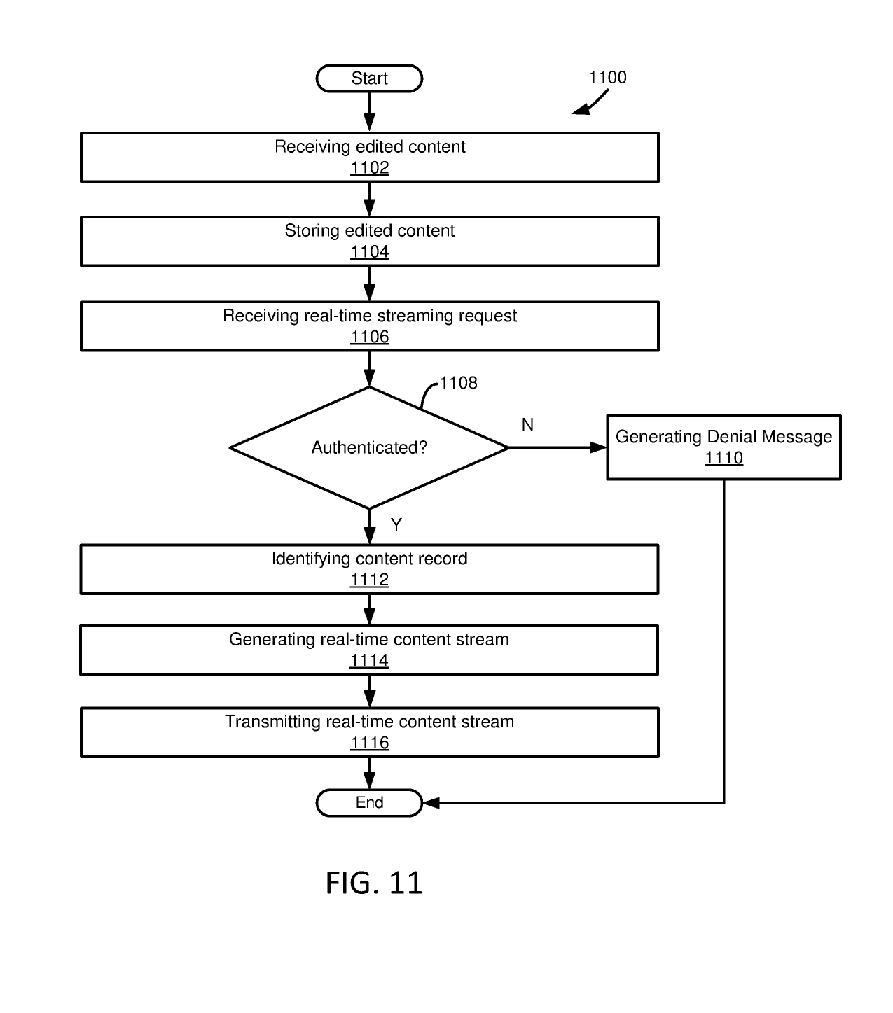

FIG. 11 shows a flowchart 1100 of an example method of operation of a content storage and streaming system.

In the example of FIG. 11, the flowchart 1100 starts at module 1102 where a content storage and streaming system receives edited content while the content is being captured. In a specific implementation, a communication engine receives the edited content.

In the example of FIG. 11, the flowchart 1100 continues to module 1104 where the content storage and streaming system stores the received content. In a specific implementation, a content management engine stores the received content in a content storage and streaming system datastore based on one or more content attributes and filter attributes associated with the received content. For example, the content management engine can generate a content record from the received content, and populate content record fields based on the content attributes associated with the received content and the filter attributes of the one or more filters used to edit the received content.

In the example of FIG. 11, the flowchart 1100 continues to module 1106 where the content storage and streaming system receives a real-time content stream request. In a specific implementation, a real-time streaming engine receives the real time content stream request.

In the example of FIG. 11, the flowchart 1100 continues to module 1108 where the content storage and streaming system authenticates the real-time content stream request. In a specific implementation, a streaming authentication engine authenticates the real-time content stream request.

In the example of FIG. 11, the flowchart 1100 continues to module 1110 where, if the real-time content stream request is not authenticated, the request is denied. In a specific implementation, the real-time content streaming engine can generate a stream denial message, and the communication engine can transmit the denial message.

In the example of FIG. 11, the flowchart 1100 continues to module 1112 where, if the real-time content stream request is authenticated, the content storage and streaming system identifies a content record in the content storage and streaming system datastore based on the real-time content stream request. In a specific implementation, the content management engine identifies the content record.

In the example of FIG. 11, the flowchart 1100 continues to module 1114 where the content storage and streaming system generates a real-time content stream including the real-time content including the content of the identified content record. In a specific implementation, the real-time content streaming engine generates the real-time content stream.

In the example of FIG. 11, the flowchart 1100 continues to module 1116 where the content storage and streaming system transmits the real-time content stream. In a specific implementation, the real-time content streaming engine transmits the real-time content stream.

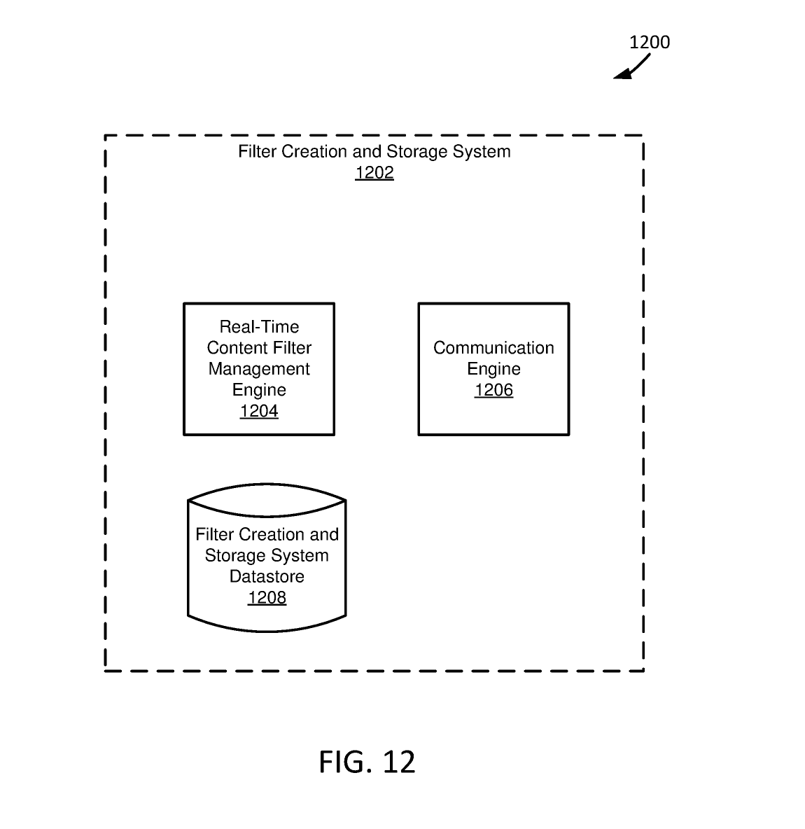

FIG. 12 shows a block diagram 1200 of an example of a filter creation and storage system 1202. In the example of FIG. 12, the filter creation and storage system 1202 includes a filter management engine 1204, a communication engine 1206, and a filter creation and storage system datastore 1208.

In the example of FIG. 12, the filter management engine 1204 functions to create, read, update, delete, or otherwise access real-time content filters stored in filter creation and storage datastore 1208. In a specific implementation, the filter management engine 1204 performs any of these operations either manually (e.g., by an administrator interacting with a GUI) or automatically (e.g., in response to a real-time edit request). In a specific implementation, real-time content filters are stored in filter records based on one or more associated filter attributes. This can help, for example, locating real-time content filters, searching for specific real-time content filters or types of real-time content filters, identifying contextually relevant real-time content filters, and so forth. Filter attributes can include some or all of the following:
Filter Identifier: an identifier that uniquely identifies the real-time content filter.
Filter Action(s): one or more editing actions caused by application of the real-time content filter to content being captured. For example, overlaying secondary content on top of content being captured, adjusting characteristics of one or more subjects within content being captured, adjusting content characteristics of content being captured, and/or the like.
Limited Input: a predetermined limited input associated with the real-time content filter, such as a limited sequence of button presses, button holds, gestures, and the like.
Limited Output: a predetermined limited output associated with the real-time content filter, such as playback device characteristics.
Content Type: one or more types of content suitable for editing with the real-time content filter. For example, content types can include audio, video, images, pictures, and/or the like.
Category: one or more categories associated with the real-time content filter. For example, categories can include music, novelists, critiques, bloggers, short commentators, and/or the like.
Default Filter: one or more identifiers that indicate the real-time content filter is a default filter for one or more associated limited interactivity content editing systems. In a specific implementation, a default filter can be automatically sent to the limited interactivity content editing system 302 in response to a received real-time edit request received from that system 302, regardless of the information included in the request.

In the example of FIG. 12, the communication engine 1206 functions to send requests to and receive data from one or a plurality of systems. The communication engine 1206 can send requests to and receive data from a system through a network or a portion of a network. Depending upon implementation-specific or other considerations, the communication engine 1206 can send requests and receive data through a connection, all or a portion of which can be a wireless connection. The communication engine 1206 can request and receive messages, and/or other communications from associated systems. Received data can be stored in the datastore 1208.

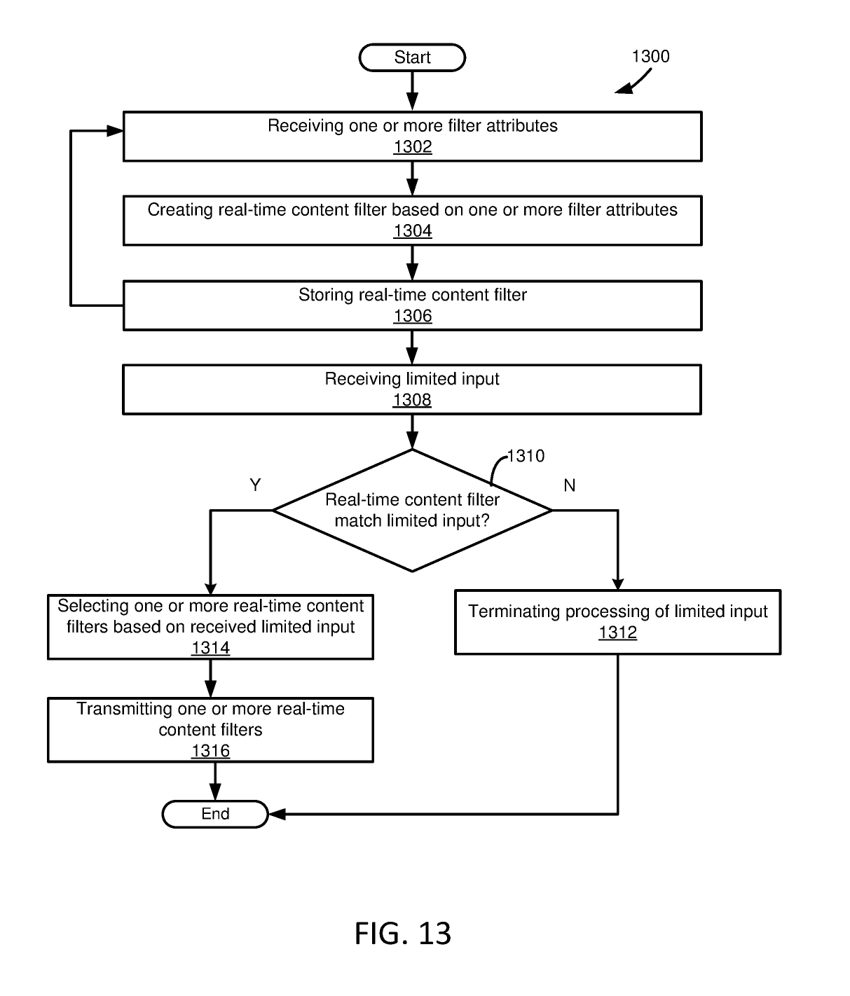

FIG. 13 shows a flowchart 1300 of an example method of operation of a filter creation and storage system.

In the example of FIG. 13, the flowchart 1300 starts at module 1302 where a filter creation and storage system receives one or more filter attributes (or, values). In a specific implementation, a filter management engine can receive the one or more filter attributes via a GUI. For example, the received filter attributes can include “music” for a filter type attribute, “audio” for a content type attribute, “a button press+swipe left gesture” for a limited input attribute, a voice modulator for a filter action attribute, “1024×768 resolution” for a limited output attribute, a randomized hash value for a filter identifier attribute, and the like.

In the example of FIG. 13, the flowchart 1300 continues to module 1304 where the filter creation and storage system generates a new real-time content filter, or updates an existing real-time content filter (collectively, generates), based on the one or more received filter attributes. In a specific implementation, the filter management engine generates the real-time content filter.

In the example of FIG. 13, the flowchart 1300 continues to module 1306 where the filter creation and storage system stores the generated real-time content filter. In a specific implementation, the generated real-time content filter is stored by the filter management engine in a filter creation and storage system datastore based on at least one of the filter attributes. For example, the generated real-time content filter can be stored in a one of a plurality of filter libraries based on the category filter attribute.

In the example of FIG. 13, the flowchart 1300 continues to module 1308 where the filter creation and storage system receives a real-time edit request. In a specific implementation, a communication engine can receive the real-time edit request, and the filter management engine can parse the real-time edit request. For example, the filter management engine can parse the real time edit request into request attributes, such a request identifier attribute, a limited input attribute, a limited output attribute, and/or a filter identifier attribute.

In the example of FIG. 13, the flowchart 1300 continues to module 1310 where the filter creation and storage system determines whether the real-time edit request matches any real-time content filters. In a specific implementation, the filter management engine makes the determination by comparing one or more of the parsed request attributes with corresponding filter attributes associated with the stored real-time content filters. For example, a match can occur if a particular request attribute (e.g., limited input attribute) matches a particular corresponding filter attribute (e.g., limited input attribute), and/or if a predetermined threshold number (e.g., 3) of request attributes match corresponding filter attributes.

In the example of FIG. 13, the flowchart 1300 continues to module 1312 if the filter creation and storage system determines no match, where the filter creation and storage system terminates processing of the real-time edit request. In a specific implementation, the communication engine can generate and transmit a termination message.

In the example of FIG. 13, the flowchart 1300 continues to module 1314 if the filter creation and storage system determines a match exists, where the filter creation and storage system retrieves the one or more matching real-time content filters. In a specific implementation, the filter management engine retrieves the matching real-time content filters from the filter creation and storage system datastore.

In the example of FIG. 13, the flowchart 1300 continues to module 1316 where the filter creation and storage system transmits the matching one or more real-time content filters. In a specific implementation, the communication engine transmits the matching one or more real-time content filters.

FIG. 14 shows a block diagram 1400 of an example of a filter recommendation system 1402. In the example of FIG. 14, the filter recommendation system 1402 includes a real-time content recognition engine 1404, a content filter recommendation engine 1406, a communication engine 1408, and a filter recommendation system datastore 1410.

In the example of FIG. 14, the real-time content recognition engine 1404 functions to identify one or more subjects within real-time content. In a specific implementation, the real-time content recognition engine 1404 performs a variety of image analyses, audio analyses, motion capture analysis, and natural language processing analyses, to identify one or more subjects. For example, the real-time content recognition engine 1404 can identify a person, voice, building, geographic feature, etc., within content being captured.

In the example of FIG. 14, the content filter recommendation engine 1406 functions to facilitate selection of one or more contextually relevant real-time content filters. In a specific implementation, the content filter recommendation engine 1406 is capable of facilitating selection of contextually relevant real-time content filters based on one or more subjects identified within real-time content. For example, an audio analysis can determine that the real-time content include music (e.g., a song, instrumentals, etc.) and identify real-time content filters associated with a music category.

In a specific implementation, the content filter recommendation engine 1406 maintains real-time content filter rules stored in the datastore 1410 associated with particular limited activity content editing systems. The content filter recommendation engine 1406 is capable of identifying one or more real-time content filters based upon satisfaction of one or more recommendation trigger conditions defined in the rules. This can, for example, help ensure that particular real-time content filters are applied during content capture and edit sessions without the limited interactivity content editing system having to specifically request the particular real-time content filters. For example, recommendation trigger conditions can include some or all of the following:
Voice Recognition Trigger: trigger condition is satisfied if the real-time content recognition engine identifies a voice of a subject with the content and the voice matches a voice associated with the trigger condition.
Facial Feature Recognition Trigger: trigger condition is satisfied if the real-time content recognition engine identifies a facial feature of a subject with the content and the facial feature matches a facial feature associated with the trigger condition.
Customized Trigger: a trigger condition predefined by a limited interactivity content editing system.

In the example of FIG. 14, the communication engine 1408 functions to send requests to and receive data from one or a plurality of systems. The communication engine 1408 can send requests to and receive data from a system through a network or a portion of a network. Depending upon implementation-specific or other considerations, the communication engine 1408 can send requests and receive data through a connection, all or a portion of which can be a wireless connection. The communication engine 1408 can request and receive messages, and/or other communications from associated systems. Received data can be stored in the datastore 1410.

FIG. 15 shows a flowchart 1500 of an example method of operation of a filter recommendation system.

In the example of FIG. 15, the flowchart 1500 starts at module 1502 where a filter recommendation system receives a real-time edit request. In a specific implementation, a communication module receives the real-time edit request.

In the example of FIG. 15, the flowchart 1500 continues to module 1504 where the filter recommendation system parses the real time edit request into request attributes, such as a request identifier attribute, a limited input attribute, a limited output attribute, and/or a filter identifier attribute. In a specific implementation, a content filter recommendation engine can parse the real-time edit request.

In the example of FIG. 15, the flowchart 1500 continues to module 1506 where the filter recommendation system identifies one or more subjects within real-time content associated with the real-time edit request. In a specific implementation, a real-time content recognition engine identifies the one or more subjects.

In the example of FIG. 15, the flowchart 1500 continues to module 1508 where the filter recommendation system identifies one or more real-time content filters based on the request attributes and/or the identified one or more subjects. For example, the filter recommendation system can identify one or more real-time content filters associated with a music category if the subject includes a music track.

In the example of FIG. 15, the flowchart 1500 continues to module 1510 where the filter recommendation system transmits the identification of the one or more real-time content filters.

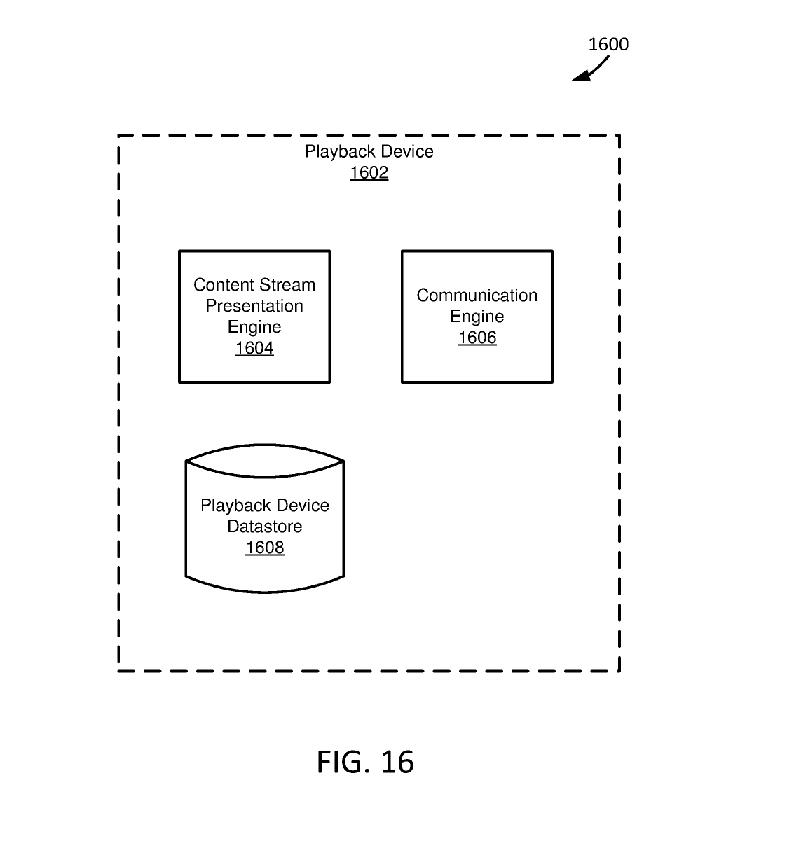

FIG. 16 shows a block diagram 1600 of an example of a playback device 1602. In the example of FIG. 16, the playback device 1602 includes a content stream presentation engine 1604, a communication engine 1606, and a playback device datastore 1608.

In the example of FIG. 16, the content stream presentation engine 1604 functions to generate requests for real-time content playback and recorded content playback, and to present real-time content and recorded content based on the requests. In a specific implementation, the content stream presentation engine 1604 is configured to receive and display real-time content streams and recorded content streams. For example, the streams can be presented via an associated display and speakers.

In the example of FIG. 16, the communication engine 1606 functions to send requests to and receive data from one or a plurality of systems. The communication engine 1606 can send requests to and receive data from a system through a network or a portion of a network. Depending upon implementation-specific or other considerations, the communication engine 1606 can send requests and receive data through a connection, all or a portion of which can be a wireless connection. The communication engine 1606 can request and receive messages, and/or other communications from associated systems. Received data can be stored in the datastore 1608.

In the example of FIG. 16, the playback device datastore 1608 functions to store playback device characteristics. In a specific implementation, playback device characteristics include display characteristics, audio characteristics, and the like.

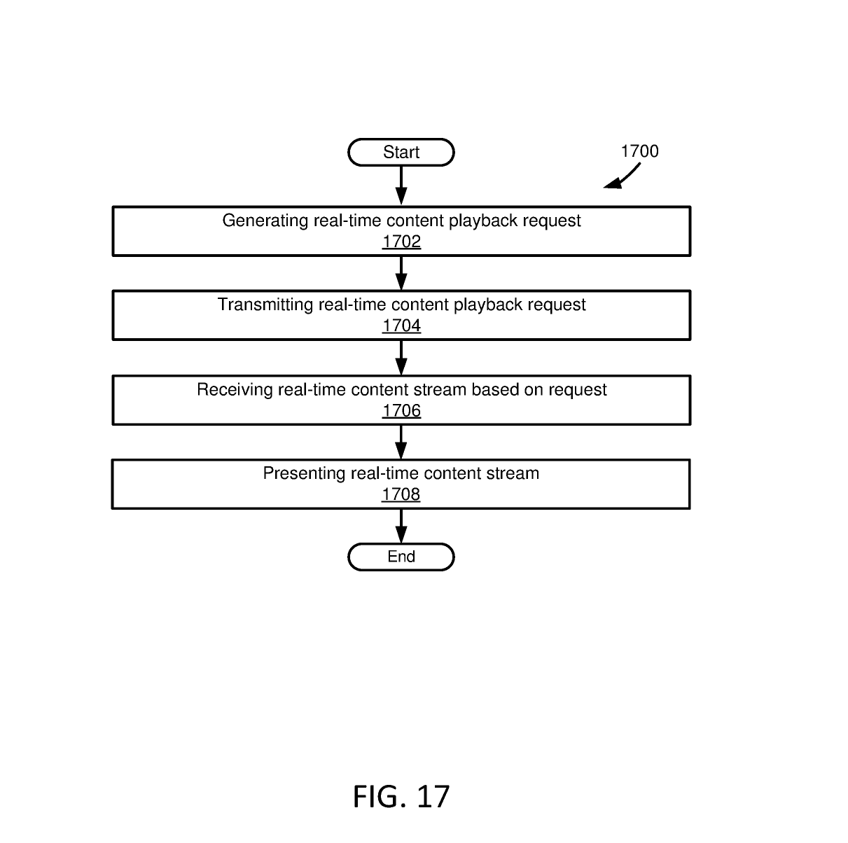

FIG. 17 shows a flowchart 1700 of an example method of operation of a playback device.

In the example of FIG. 17, the flowchart 1700 starts at module 1702 where a playback device generates a real-time content playback request. In a specific implementation, the a content stream presentation engine generates the request.

In the example of FIG. 17, the flowchart 1700 continues to module 1704 where the playback device transmits the real-time content request. In a specific implementation, a communication module transmits the request.

In the example of FIG. 17, the flowchart 1700 continues to module 1706 where the playback device receives a real-time content stream based on the request. In a specific implementation, the communication module transmits the request.

In the example of FIG. 17, the flowchart 1700 continues to module 1708 where the playback device presents the real-time content stream. In a specific implementation, the content stream presentation engine presents the real-time content stream.

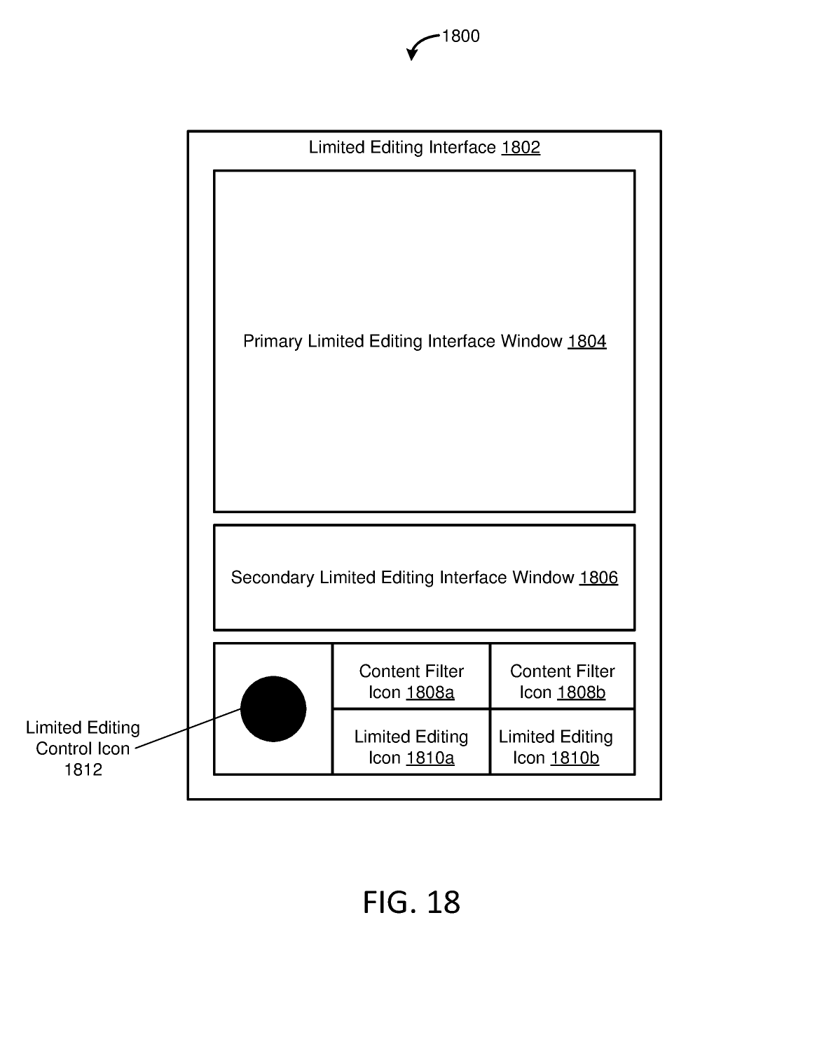

FIG. 18 shows an example of a limited editing interface 1802. For example, the limited editing interface 1802 can include one or more graphical user interfaces (GUIs), physical buttons, scroll wheels, and the like, associated with one or more mobile devices (e.g., the one or more mobile devices performing the functionality of a limited interactivity content editing system). More specifically, the limited editing interface 1802 includes a primary limited editing interface window 1804, a secondary limited editing interface window 1806, content filter icons 1808a-b, limited editing icons 1810a-b, and a limited editing control (or, “record”) icon 1812.

In a specific implementation, the primary limited editing interface window 1804 comprises a GUI window configured to display and control editing or playback of one or more portions of content. For example, the window 1804 can display time location values associated with content, such as a start time location value (e.g., 00 m:00 s), a current time location value (e.g., 02 m:10 s), and an end time location value (e.g., 03 m:00 s). The window 1804 can additionally include one or more features for controlling content playback (e.g., fast forward, rewind, pause, play, etc.). For example, the one or more features can include a graphical scroll bar that can be manipulated with limited input, e.g., moving the slider forward to fast forward, moving the slider backwards to rewind, and so forth.

In a specific implementation, the secondary limited editing interface window 1806 comprises a GUI window configured to display graphics associated with one or more portions of content during playback. For example, the window 1806 can display text of audio content during playback.

In a specific implementation, the content filter icons 1808a-b are configured to select a content filter in response to limited input. For example, each of the icons 1808a-b can be associated with a particular content filter, e.g., a content filter for modulating audio characteristics, and the like.

In a specific implementation, the limited editing icons 1810a-b are configured to select a limited editing rule (e.g., silence limited editing rule) in response to limited input. For example, each of the icons 1810a-b can be associated with a particular limited editing rule.

In a specific implementation, the limited editing control icon 1812 is configured to edit content in response to limited input. For example, holding down, or pressing, the icon 1812 can edit content based on one or more selected content filters and/or limited rules. The limited editing icon 1812 can additionally be used in conjunction with one or more other features of the limited editing interface 1802. For example, holding down the limited editing control icon 1812 at a particular content time location (e.g., 02 m:10 s) and fast forwarding content playback to a different content time location (e.g., 02 m:45 s) can edit the portion of content between those content time locations, e.g., based on one or more selected content filters and/or limited rules.

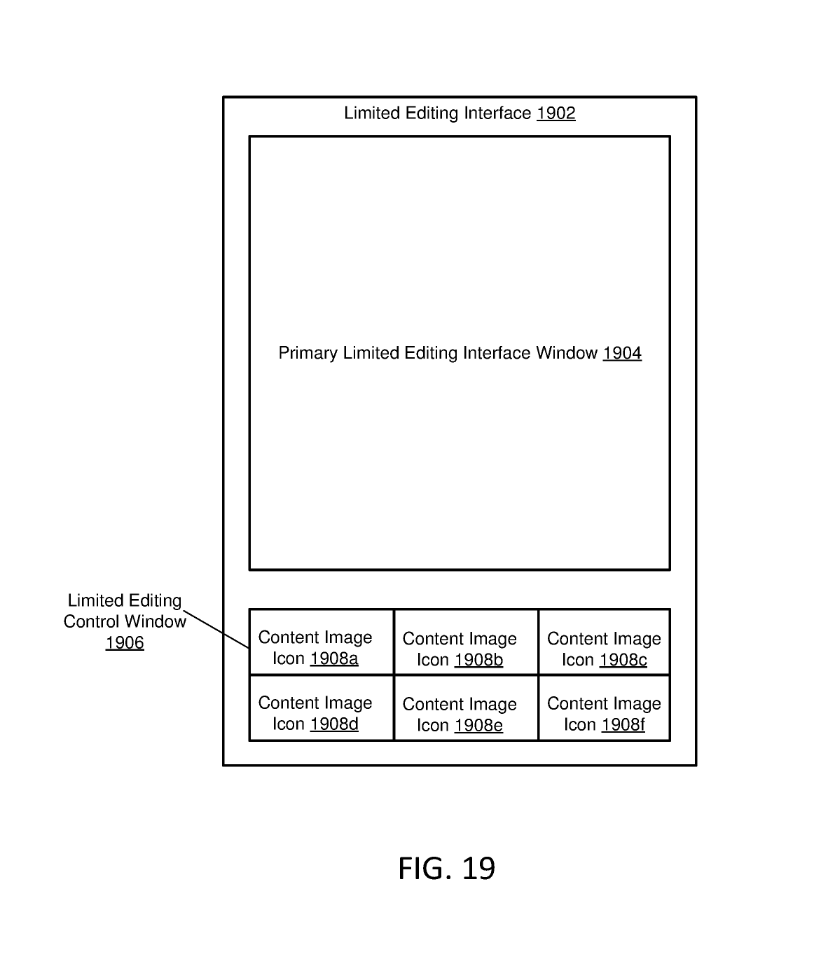

FIG. 19 shows an example of a limited editing interface 1902. For example, the limited editing interface 1902 can include one or more graphical user interfaces (GUIs), physical buttons, scroll wheels, and the like, associated with one or more mobile devices (e.g., the one or more mobile devices performing the functionality of a limited interactivity content editing system). More specifically, the limited editing interface 1902 includes a limited editing interface window 1904, a limited editing control window 1906, and content image icons 1906a-f.

In a specific implementation, the primary limited editing interface window 1904 comprises a GUI window configured to control editing or playback of one or more portions of content. For example, the window 1904 can display time location values associated with content, such as a start time location value (e.g., 00 m:00 s), a current time location value (e.g., 02 m:10 s), and an end time location value (e.g., 03 m:00 s). The window 1904 can additionally include one or more features for controlling content editing or playback (e.g., fast forward, rewind, pause, play, etc.). For example, the one or more features can include a graphical scroll bar that can be manipulated with limited input, e.g., moving the slider forward to fast forward, moving the slider backwards to rewind, and so forth.

In a specific implementation, the limited editing control window 1906 is configured to associate one or more images with audio content in response to limited input (e.g., based on audio image limited editing rules). For example, holding down, or pressing, one of the content image icons 1908a-f can cause the one or more images associated with that content image icon to be displayed during playback of the audio content. The limited editing control window 1906 can additionally be used in conjunction with one or more other features of the limited editing interface 1902. For example, holding down one of the content image icons 1906a-f at a particular content time location (e.g., 02 m:10 s) and fast forwarding content playback to a different content time location (e.g., 02 m:45 s) can cause the one or more images associated with that content image icon to be displayed during playback of the audio content between those content time locations.

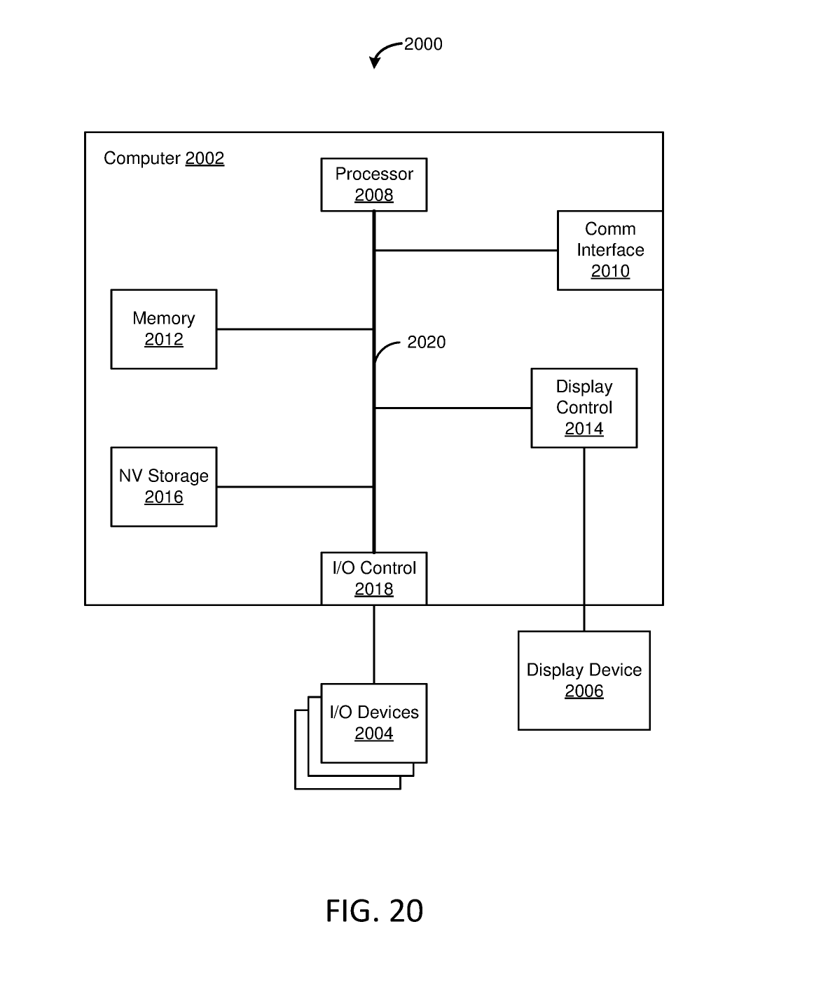

FIG. 20 shows a block diagram 2000 of an example of a computer system 2002, which can be incorporated into various implementations described in this paper. For example, the limited interactivity content editing system 104, the content storage and streaming system 106, the filter creation and storage system 108, the filter recommendation system 110, and the playback devices 112 can each comprise specific implementations of the computer system 2000. The example of FIG. 20, is intended to illustrate a computer system that can be used as a client computer system, such as a wireless client or a workstation, or a server computer system. In the example of FIG. 20, the computer system 2000 includes a computer 2002, I/O devices 2004, and a display device 2006. The computer 2002 includes a processor 2008, a communications interface 2010, memory 2012, display controller 2014, non-volatile storage 2016, and I/O controller 2018. The computer 2002 can be coupled to or include the I/O devices 2004 and display device 2006.

The computer 2002 interfaces to external systems through the communications interface 2010, which can include a modem or network interface. It will be appreciated that the communications interface 2010 can be considered to be part of the computer system 2000 or a part of the computer 2002. The communications interface 2010 can be an analog modem, ISDN modem, cable modem, token ring interface, satellite transmission interface (e.g. “direct PC”), or other interfaces for coupling a computer system to other computer systems.

The processor 2008 can be, for example, a conventional microprocessor such as an Intel Pentium microprocessor or Motorola power PC microprocessor. The memory 2012 is coupled to the processor 2008 by a bus 2020. The memory 2012 can be Dynamic Random Access Memory (DRAM) and can also include Static RAM (SRAM). The bus 2020 couples the processor 2008 to the memory 2012, also to the non-volatile storage 2016, to the display controller 2014, and to the I/O controller 2018.

The I/O devices 2004 can include a keyboard, disk drives, printers, a scanner, and other input and output devices, including a mouse or other pointing device. The display controller 2014 can control in the conventional manner a display on the display device 2006, which can be, for example, a cathode ray tube (CRT) or liquid crystal display (LCD). The display controller 2014 and the I/O controller 2018 can be implemented with conventional well known technology.

The non-volatile storage 2016 is often a magnetic hard disk, an optical disk, or another form of storage for large amounts of data. Some of this data is often written, by a direct memory access process, into memory 2012 during execution of software in the computer 2002. One of skill in the art will immediately recognize that the terms “machine-readable medium” or “computer-readable medium” includes any type of storage device that is accessible by the processor 2008 and also encompasses a carrier wave that encodes a data signal.

The computer system illustrated in FIG. 20 can be used to illustrate many possible computer systems with different architectures. For example, personal computers based on an Intel microprocessor often have multiple buses, one of which can be an I/O bus for the peripherals and one that directly connects the processor 2008 and the memory 2012 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 2012 for execution by the processor 2008. A Web TV system, which is known in the art, is also considered to be a computer system, but it can lack some of the features shown in FIG. 20, such as certain input or output devices. A typical computer system will usually include at least a processor, memory, and a bus coupling the memory to the processor.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described in this paper relate to apparatus for performing the operations. The apparatus can be specially constructed for the required purposes, or it can comprise a general purpose computer selectively activated or reconfigured by a computer program stored in the computer. Such a computer program can be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

For purposes of explanation, numerous specific details are set forth in order to provide a thorough understanding of the description. It will be apparent, however, to one skilled in the art that implementations of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., steps, modules, blocks, structures, devices, features, etc.) may be variously combined, separated, removed, reordered, and replaced in a manner other than as expressly described and depicted herein.

The language used herein has been principally selected for readability and instructional purposes, and it may not have been selected to delineate or circumscribe the inventive subject matter. It is therefore intended that the scope be limited not by this detailed description, but rather by any claims that issue on an application based hereon. Accordingly, the disclosure of the implementations is intended to be illustrative, but not limiting, of the scope, which is set forth in the claims recited herein.

We claim:

1. A method comprising:
storing a first real-time content filter and a second real-time content filter, the first real-time content filter being associated with a first predetermined limited input, and the second real-time content filter being associated with a second predetermined limited input, the first predetermined limited input being different from the second predetermined limited input;
capturing content of a subject;
receiving a first limited input;
determining, responsive to receiving the first limited input, whether the first limited input matches any of the first predetermined limited input or the second predetermined limited input;
selecting, responsive to a determination the first limited input matches the first predetermined limited input, the first real-time content filter; and
editing, responsive to the determination the first limited input matches the first predetermined limited input, a first portion of the content using the first real-time content filter while the content is being captured.

2. The method of claim 1, further comprising:
receiving a second limited input;
determining, responsive to receiving the second limited input, whether the second limited input matches the second predetermined limited input;
selecting, responsive to a determination the second limited input matches the second predetermined limited input, the second real-time content filter; and
editing, responsive to the determination the second limited input matches the second predetermined limited input, a second portion of the content using the second real-time content filter while the content is being captured.

3. A method comprising:
receiving a first limited input;
setting, based on the first limited input, a limited editing start point associated with recorded audio content;
receiving a second limited input;
setting, based on the second limited input, a limited editing end point associated with the recorded audio content; and
performing a limited editing action on a particular portion of the recorded audio content, the particular portion of the recorded content defined based on the limited editing start point and the limited editing end point.

4. The method of claim 3, wherein the first limited input comprises pressing and holding a button of a graphical user interface (GUI).

5. The method of claim 4, wherein the second limited input comprises releasing the button of the GUI.

6. The method of claim 3, wherein the limited editing action comprises any of a silence editing action, a delete editing action, or an audio image editing action.

7. The method of claim 6, wherein the silence editing action comprises inserting an empty portion of content into the recorded content beginning at the limited editing start point and terminating at the limited editing end point.

8. The method of claim 6, wherein the delete editing action comprises removing a particular portion of audio content from the recorded audio content, the particular portion of audio content beginning at the limited editing start point and terminating at the limited editing end point.

9. The method of claim 6, wherein the audio image editing action comprising linking one or more images to a particular portion of audio content from the recorded audio content, the particular portion of audio content beginning at the limited editing start point and terminating at the limited editing end point.

10. The method of claim 5, wherein the second limited input further comprises moving a slider of the GUI, prior to releasing the button of the GUI, to select the limited editing end point, the releasing of the button of the GUI setting the limited editing end point to the selected limited editing end point.

11. A system comprising:
a limited input engine configured to receive a first limited input and a second limited input; and
a limited editing engine configured to:
set a limited editing start point associated with recorded audio content, the limited editing start point based on the first limited input,
set a limited editing end point associated with the recorded audio content, the limited editing end point based on the second limited input, and
perform a limited editing action on a particular portion of the recorded audio content, the particular portion of the recorded content defined based on the limited editing start point and the limited editing end point.

12. The system of claim 11, wherein the first limited input comprises pressing and holding a button of a graphical user interface (GUI).

13. The system of claim 12, wherein the second limited input comprises releasing the button of the GUI.

14. The system of claim 11, wherein the limited editing action comprises any of a silence editing action, a delete editing action, or an audio image editing action.

15. The method of claim 11, wherein the silence editing action comprises inserting an empty portion of content into the recorded content beginning at the limited editing start point and terminating at the limited editing end point.

16. The method of claim 11, wherein the delete editing action comprises removing a particular portion of audio content from the recorded audio content, the particular portion of audio content beginning at the limited editing start point and terminating at the limited editing end point.

17. The method of claim 11, wherein the audio image editing action comprising linking one or more images to a particular portion of audio content from the recorded audio content, the particular portion of audio content beginning at the limited editing start point and terminating at the limited editing end point.

18. The system of claim 12, wherein second limited input further comprises moving a slider of the GUI, prior to releasing the button of the GUI, to select the limited editing end point, the releasing of the button of the GUI setting the limited editing end point to the selected limited editing end point.

19. A non-transitory computer readable medium comprising executable instructions, the instructions being executable by a processor to perform a method, the method comprising:
receiving a first limited input;
setting, based on the first limited input, a limited editing start point associated with recorded audio content;
receiving a second limited input;
setting, based on the second limited input, a limited editing end point associated with the recorded audio content; and
performing a limited editing action on a particular portion of the recorded audio content, the particular portion of the recorded content defined based on the limited editing start point and the limited editing end point.

20. A system comprising:
a means for receiving a first limited input;
a means for setting, based on the first limited input, a limited editing start point associated with recorded audio content;
a means for receiving a second limited input;
a means setting, based on the second limited input, a limited editing end point associated with the recorded audio content; and
a means for performing a limited editing action on a particular portion of the recorded audio content, the particular portion of the recorded content defined based on the limited editing start point and the limited editing end point.
